(19) United States
(12) Patent Application Publication
(10) Pub. No.: US 2014/0372528 A1
(43) Pub. Date: Dec. 18, 2014

(54) INFORMATION PROCESSING SYSTEM, INFORMATION PROCESSING APPARATUS, AND RECORDING MEDIUM

(71) Applicant: FUJITSU LIMITED, Kawasaki-shi (JP)

(72) Inventor: Naoki Nishiguchi, Kawasaki (JP)

(73) Assignee: FUJITSU LIMITED, Kawasaki-shi (JP)

(21) Appl. No.: 14/256,318

(22) Filed: Apr. 18, 2014

(30) Foreign Application Priority Data
Jun. 13, 2013 (JP) 2013-124989

(51) Int. Cl. H04L 12/911; H04L 12/26

(52) U.S. Cl. CPC H04L 47/70; H04L 43/08
USPC 709/204

(57) ABSTRACT

An information processing system includes first and second terminals which are in communication with each other via one or more computers on a network, so that a process of the second terminal is executed by the first terminal via the network. Further, the second terminal includes: an access proxy unit acquiring a request from the first terminal via the one or more computers on the network, constructing a process sequence corresponding to the acquired request, and outputting a process result corresponding to the constructed process sequence, and an execution unit executing a process corresponding to the constructed process sequence.

### CROSS-REFERENCE TO RELATED APPLICATION

This application is based upon and claims the benefit of priority of the prior Japanese Patent Application No. 2013-124989, filed on Jun. 13, 2013, the entire contents of which are incorporated herein by reference.

### FIELD

The embodiment discussed herein is related to an information processing system, an information processing apparatus, and an information processing program.

### BACKGROUND

Cloud computing (hereinafter simplified as “Cloud”) is known as a platform for using computer resources in a communication network such as the Internet. For example, the “Cloud” refers to a system which executes a target process by using one or more information processing apparatuses (computers) so as to request for executing a process on a contract basis, etc.

Further, the “Cloud” can be accessed from a plurality of terminals, so that a Cloud service has become popular, in which, for example, files are located in the Cloud so as to be accessible from various terminals as the shared information.

However, not a few users are reluctant to put their private information in the Cloud due to concerns about privacy and security. To resolve the problem, there exists a service in which, for example, information is stored in the terminal that cannot be externally accessed by others (hereinafter referred to as a “home terminal”), so that the information is desired to be accessed to the home terminal via the Cloud (see, for example, Japanese Laid-open Patent Publication Nos. 2009-245328, 2002-141953, and 2000-148642).

### SUMMARY

According to an aspect of the present invention, an information processing system includes first and second terminals which are in communication with each other via one or more computers on a network, so that a process of the second terminal is executed by the first terminal via the network.

Further, the second terminal includes: an access proxy unit acquiring a request from the first terminal via the one or more computers on the network, constructing a process sequence corresponding to the acquired request, and outputting a process result corresponding to the constructed process sequence, and an execution unit executing a process corresponding to the constructed process sequence.

The objects and advantages of the embodiments disclosed herein will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 illustrates an example configuration of an information processing system;

FIG. 2 illustrates an example hardware configuration of a request terminal;

FIG. 3 illustrates an example hardware configuration of a home terminal;

FIG. 4 is an example sequence diagram of a service providing process in home use;

FIG. 5 is an example flowchart illustrating a process of a network monitoring section;

FIGS. 6A and 6B illustrate example data in the network monitor;

FIG. 7 is an example flowchart of a process of a Push client;

FIG. 8 is an example flowchart of a process of a Push service;

FIG. 9 is an example flowchart of a process of a process receiving section;

FIGS. 10A and 10B illustrate example data in the home use;

FIG. 11 is an example sequence diagram of a service providing process in out-of-home use;

FIG. 12 is an example flowchart of process by a Cloud Push client;

FIG. 13 is an example flowchart of a connection control process by a home Push client;

FIG. 14 is an example flowchart of a generated process of a client;

FIG. 15 is an example flowchart of a process by an access relay section;

FIG. 16 is an example flowchart of a process of step S167 in FIG. 15;

FIGS. 17A and 17B illustrate an example of sequence and response;

FIG. 18 is an example flowchart of a process by a service construction section;

FIG. 19 is an example flowchart of a process of step S195 in FIG. 18;

FIGS. 20A and 20B illustrate an example sequence of service use;

FIGS. 21A through 20C illustrate an example of a construction service instance;

FIG. 22 is an example flowchart of a process of a Cloud Push service;

FIG. 23 is an example flowchart of a process of a home Push service;

FIG. 24 is an example flowchart of a process of a Cloud process receiving section;

FIG. 25 is an example flowchart of a process of a service registration section;

FIGS. 26A and 26B illustrate example data of a registration service;

FIG. 27 an example flowchart of a process of a service execution section;

FIGS. 28A and 28B illustrate example data of a request;

FIGS. 29A through 29C illustrate a specific example data in service use; and

FIG. 30 illustrates examples of screens on the request terminal in the service use.

### DESCRIPTION OF EMBODIMENT

In a related technology, for example, in a case where a new service is added to the home terminal, in order to allow an access to the home terminal from outside of the home, it is desired to modify, for example, the Cloud side and the home terminal. This is because, for example, when considering a case that a terminal that requests for a service (hereinafter referred to as a “request terminal”) is located in the home, it is possible for the request terminal to directly access the home terminal and use the information stored in the home terminal.

On the hand, however, when the request terminal is disposed outside of the home, it is not possible for the request terminal to directly access a home service via the Cloud. Namely, it is desired to provide a dedicated service to go between the Cloud and the home service. Also, it is desired for the Cloud side to provide a service to accept a process for the home service and a method for requesting the process to the home terminal.

Further, it may also be desired to provide a service to report a result of the home service to the request terminal. In this regard, it is also desired for the request terminal to provide a method of accessing the home service and an application that allows to externally access the home application if the method of accessing the home service when the request terminal is in the home differs from the method of externally accessing the home service when the request terminal is disposed outside the home.

Therefore, in order to make it possible to externally access the home service from outside the home, it is desired to modify many parts and it is not possible to easily provide a desired service.

According to an embodiment, the present invention may provide an information processing system, an information processing apparatus, and an information processing program capable of providing a desired service.

In the following, embodiments are described with reference to the accompanying drawings.

### Example Configuration of Information Processing System

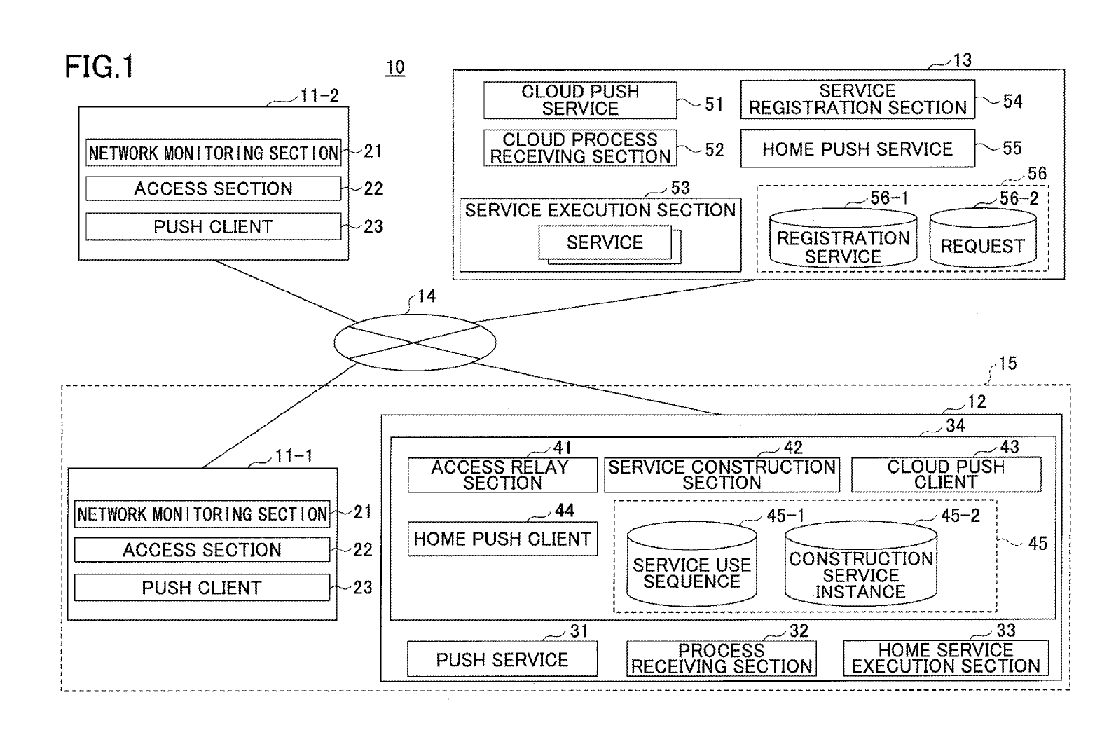

FIG. 1 illustration an example configuration of an information processing system. The information processing system 10 in FIG. 1 includes a request terminal (“first terminal”) 11 and a home terminal (“second terminal”) 12 and a Cloud 13. In the example of FIG. 1, the information processing system 10 is a system (“home cloud system”) in which the request terminal 11 uses a service, which is provided by the home terminal 12, via the Cloud 13. In the example of FIG. 1, the request terminal 11, the home terminal (“second terminal”) 12, and the Cloud 13 are connected to each other via a communication network 14 such as a Local Area Network (LAN), so that data can be transmitted and received therebetween.

The request terminal 11 uses, for example, a home service which is provided by the home terminal 12. In the example of FIG. 1, two request terminals 11-1 and 11-2 are described. However, it should be noted that the number of the request terminals is not limited to two. In the example of FIG. 1, the request terminal 11 is in direct communication with the home terminal 12 without using the Cloud 13, so as to use a service which is executed by the home terminal 12 (hereinafter referred to as a “home service”). For example, the home service refers to, but is not limited to, a service that uses private information which should not be used by others.

The request terminal 11-1 may be in communication with the home terminal 12 using wireless infrared technology to use a home service in a home area 15. Further, for example, the request terminal 11-1 may use a near field communication via a relay apparatus (e.g., an access point) based on “Wi-Fi” (registered trademark) or “Bluetooth” (registered trademark).

On the other hand, the request terminal 11-2 is located outside the home area 15 (hereinafter an “out-of-home area”) and may use the home service, which is provided by the home terminal 12, via the Cloud 13.

The request terminal 11 may be, for example, a mobile communication terminal such as a tablet terminal, a smartphone, and a cellular phone. Therefore, one request terminal may be the request terminal 11-1 and the request terminal 11-2 depending on the position (movement) of the request terminal 11.

The home terminal 12 provides the home service to the request terminal 11. The home terminal 12 is a terminal which, for example, a third person having no authority can access, and may be, for example, but is not limited to, a Personal Computer (PC) or a server. In this regard, the home terminal 12 may be a private PC installed in the user's home or may be an internal server usable by, for example, employees only in the firm.

The Cloud 13 includes, for example, one or more information processing apparatuses (computers) on a communication network 14. The Cloud 13 relays communications between the request terminal 11-2 and the home terminal 12 when, for example, the request terminal 11-2 in the out-of-home area uses the home service. The communication network 14 may be wired or wireless network or may be a combination thereof.

In this embodiment, the information processing system 10 has a function to act as a proxy to access the home service which is in the home terminal 12. In the case of the access from the out-of-home area, the access proxy accesses the home service. Further, the information processing system 10 reproduces the home service on the Cloud 13 based on a result of the access by the access proxy. By doing this, it becomes possible for the request terminal in the out-of-home area to use the home service by using the service on the Cloud 13.

Further, in a home service in the related technologies, it is desired to add a module dedicated to the home service for the Cloud 13 and the home terminal. In this embodiment, however, what is desired is to register an access sequence to act as a proxy to access the home service in the home terminal 12. In this embodiment, by registering the sequence to use the service as well as installing the home service of the home terminal 12, it becomes possible to use the service not only in the home but also from out of the home.

Further, in this embodiment, all the information stored in the home terminal 12 is not reproduced on the Cloud 13. Namely, only the information requested from the request terminal 11 is the target to be reproduced. Therefore, it becomes possible to provide an appropriate service having enhanced security.

Next, the functional configurations of the request terminal 11, the home terminal (“second terminal”) 12, and the Cloud 13 are described with reference to the accompanying drawings.

### Example Functional Configuration of Request Terminal 11

The request terminal 11 of FIG. 1 includes a network monitoring section 21, an access section 22, and a Push client 23 which is an example of a service acquisition section.

The network monitoring section 21 constantly monitors, for example, a connection state of the network. When the connection state is changed, the network monitoring section 21 determines whether the connection state after the change is in-home or out-of-home. Based on the determination result, the network monitoring section 21 determines the connection destination.

Further, when the access section 22 or the Push client 23 inquires the connection destination from the network monitoring section 21, the network monitoring section 21 transmits the determined connection destination to the access section 22 or the Push client 23, respectively. Further, for example, the network monitoring section 21 may acquire the positional information of the request terminal 11 using a Global Positioning System (GPS), determines whether the request terminal 11 is in the home area 15 or the out-of-home area based on the acquired positional information, and further determine the connection destination based on the determination result.

The access section 22 sends a request for executing a process to a Cloud process receiving section 52 of the Cloud 13 or a process receiving section 32 of the home terminal 12 for processing. The access section 22 acquires the information of the connection destination from the network monitoring section 21.

Further, the access section 22 receives an access permission notification from the Push client 23, and uses the home service for the home terminal 12 and Cloud 13. For example, when the request terminal 11 is located in the home area 15, the request terminal 12 directly accesses the home terminal 12, and when the request terminal 11 is located in the out-of-home area, the request terminal 11 accesses the Cloud 13. The above processes in the access section 22 may be realized (executed) by using, for example, but not limited to, a predetermined application (access application).

For example, the Push client 23 acquires a service by Push distribution from the request contact. When the request terminal is in the home area 15, the Push client 23 receives the home service from the home terminal 12, and when the request terminal 11 is in the out-of-home area (out of the home area 15), the Push client 23 receives the home service from the Cloud 13. Further, when a predetermined communication is established, the Push client 23 sends the access permission notification to the access section 22.

### Example Functional Configuration of Home Terminal 12

The home terminal 12 of FIG. 1 includes a Push service 31, which is an example of a service providing section, the process receiving section 32, a home service execution section 33, and an access proxy section 34.

The home terminal 12 provides a service to the request terminal 11-1 in the home area 15 by using, for example, the Push service 31, the process receiving section 32, and the home service execution section 33. Further, the home terminal 12 provides a service to the request terminal 11-2 in the out-of-home area via the Cloud 13 by using the Push service 31, the process receiving section 32, the home service execution section 33, and the access proxy section 34.

The Push service 31 transmits (Pushes) a service access notification to the request terminal 11-1. By doing this, it becomes possible for the request terminal 11-1 to asynchronously access the home service. The term “asynchronously” herein refers to a case where, for example, after the request terminal 11-0 requests for a process, the request terminal 11-0 does not wait for the completion of the process but asynchronously receives the result (the service) by Push distribution etc. when the process in the home terminal 12 is completed.

The process receiving section 32 receives a process request from the request terminal 11-1. Further, the process receiving section 32 reports (outputs) the acceptance of the process request to the request terminal 11-1. The process receiving section 32 requests the requested process (e.g., service access) to the Push service 31.

The process receiving section 32 can directly communicate with (access) the request terminal 11-1 in the home area 15 via an access point (hereinafter referred to as an “AP”) such as a wireless LAN.

Based on the contents of the process request from the request terminal 11-1 in the home area 15 and the contents of the process request acquired from the request terminal 11-2 via the Cloud 13, the home service execution section 33 executes the corresponding home services and outputs the results thereof to the corresponding request terminals 11.

When the request terminal 11 is in the out-of-home area, based on the contents of the process request acquired via the Cloud 13, the access proxy section 34 executes the home service corresponding to the contents of the process request acquired via the Cloud 13 and outputs the results of the execution to the Cloud 13.

The access proxy section 34 includes an access relay section 41, a service construction section 42, a Cloud Push client 43, which is an example of a Cloud communication section, a home Push client 44, which is an example of a home communication section, and a storage section 45. The storage section 45 includes a service use sequence 45-1 and a construction service instance 45-2.

The access relay section 41 notifies the process receiving section 32 of the process request from the client terminal 11 based on, for example, the service use sequence 45-1. The access relay section 41 notifies the home service execution section 33 of bi-directional information exchange such as the registration of the information of the home service from the client terminal 11.

Based on the service use sequence 45-1, the service construction section 42 accesses the home service execution section 33, constructs a temporary service by using the results of the access, and notifies a service registration section 52 of the Cloud 13 of the temporary service. The data (response) acquired by the access relay section 41 and the service construction section 42 are stored in the construction service instance 45-2.

The Cloud Push client 43 is in connection with a home Push service 55 of the Cloud 13 described below. Upon receiving a request from the home Push service 55, the Cloud Push client 43 generates the home Push client 44.

The home Push client 44 is in connection with the Push service 31. By doing this, it is ready for the request terminal 11-2 to asynchronously access the home service. Further, the home Push client 44 sends the service access notification to the service construction section 42.

The storage section 45 stores the data to be used in various processes in the home terminal 12. Further, the data stored in the storage section 45 are not limited to the service use sequence 45-1 and the construction service instance 45-2. For example, the address information which is used for identifying the Cloud 13, the request terminal 11 and the like and for the data transmission and reception, the user information, and the information of the processing result may be stored in the storage section 45.

The service use sequence 45-1 includes, for example, a construction sequence and a relay sequence. The construction sequence includes the information indicating, for example, a path (address information), a method, a request, a response, an access necessity flag. The information of the service use sequence 45-1 is not limited to those. Further, the construction service instance 45-2 includes, for example, but not limited to, information indicating a relationship between an acceptance ID and a Cloud acceptance ID and response information when a service is used.

### Example Functional Configuration of Cloud 13

The Cloud 13 of FIG. 1 includes a Cloud Push service 51, which is an example of a Cloud service providing section, a Cloud process receiving section 52, a service execution section 53, a service registration section 54, which is an example of a registration section, the home Push service 55, which is an example of home service providing section, and a storage section 56. The storage section 56 includes a registration service 56-1 and a request 56-2.

The Cloud Push service 51 sends the service access notification to the request terminal 11-2 which is in the out-of-home area. Further, the Cloud Push service 51 requests the home Push service 55 for issuing a connection notification. By doing this, the home Push service 55 sends the connection notification to the access proxy section 34.

The Cloud process receiving section 52 receives the request from the request terminal 11, and executes the process corresponding to the request content. For example, the Cloud process receiving section 52 requests the home Push service 55 for a process request notification which corresponds to the received request content.

The service execution section 53 executes a process when the access section 22 of the request terminal 11 accesses the home service which is constructed in the Cloud 13, and requests the home Push service 55 for an access termination notification when the access from the access section 22 terminates.

Further, in order to provide a service in the Cloud 13, the service execution section 53 generates a region for the service where the Cloud acceptance ID is used as a key in the registration service 56-1. The service execution section 53 can execute one or more services.

The service registration section 54 registers the service requested from the service construction section 42 of the home terminal 54. The service registration section 54 registers for example, the processing result of the home service in the home terminal 12. After the registration is finished, the service registration section 54 requests the Cloud Push service 51 for the service access notification.

The home Push service 55 sends the connection notification of the request terminal 11 to the Cloud Push client 43 of the home terminal 12. Further, the home Push service 55 transmits the process request from the request terminal 11 to the Cloud Push client 43 of the home terminal 12.

Further, the home Push service 55 notifies the Cloud Push client 43 of the home terminal 12 of the access termination. Further, the home Push service 55 transmits a terminate notification of the request terminal 11 to the Cloud Push client 43 of the home terminal 12.

The storage section 56 stores data which are desired for the execution of various processes by the Cloud 13. Here, the data are not limited to the registration service 56-1 and the request 56-2. For example, the storage section 56 may store the address information which is used for identifying the home terminal 12, the request terminal 11 and the like and for the data transmission and reception, the user information, and the information of the processing result.

The registration service 56-1 stores, for example, predetermined information for each of the services and registrations. The registration service 56-1 stores, for example, but not limited to, the Cloud acceptance ID (service identifier), a device ID, a Cloud ID, a service ID, and a URL for each of the services.

The registration service 56-1 stores, for example, but not limited to, the information indicating the path, the method, the response, an end flag and the like for each of the registrations. Further, the request 56-2 refers to, for example, a request content for each of the requests. The request 56-2 may include, but not limited to, the information indicating the path, the method, the response and the like.

In this embodiment, the address information (e.g., the URL) of the access destination differs between the home terminal 12 and the Cloud 13 which are the access destinations of request terminal. Therefore, it is desired for the request terminal 11 to determine which of the home area or the out-of-home area to be accessed and switch (or determine) the URL of the access destination based on the determination result.

For example, in the determination of the access destination, it is determined whether the request terminal is located in the home area 15 or the out-of-home area. This determination may be made based on, for example, the Extended Service Set Identifier (ESSID) of Wi-Fi, or the Media Access Control (MAC) address of the gateway included in the communication network 14. For example, when the ESSID or the MAC address corresponds to the information used in the home terminal 12, it is determined that the request terminal 11 is located in the home area 15. Otherwise, it is determined that the request terminal is out of the home area 15.

However, the determination method is not limited to this method. By using such a method to determine whether the request terminal 11 is located in the home area 15 or out of the home area 15, it becomes possible to set the URL of the access destination.

Further, the URLs of the home area and the out-of-home area can be set by, for example, changing the host name and the path. For example, when the path is used, the Cloud ID may be used to identify the home terminal 12 in the Cloud, and the Cloud ID is added to the header of the path. By doing this, in the Cloud 13, it becomes possible to identify the home terminal 12 by using the Cloud ID on the header of the path.

Further, the Cloud ID may also be passed by adding an argument in place of the path. Further, in this embodiment, a scheme such as “http” may be changed in place of the host name of the path when the URL is generated.

### Example Hardware Configuration

Next, example hardware configurations of the request terminal 11 and the home terminal 12 are described.

### Example Hardware Configuration of Request Terminal 11

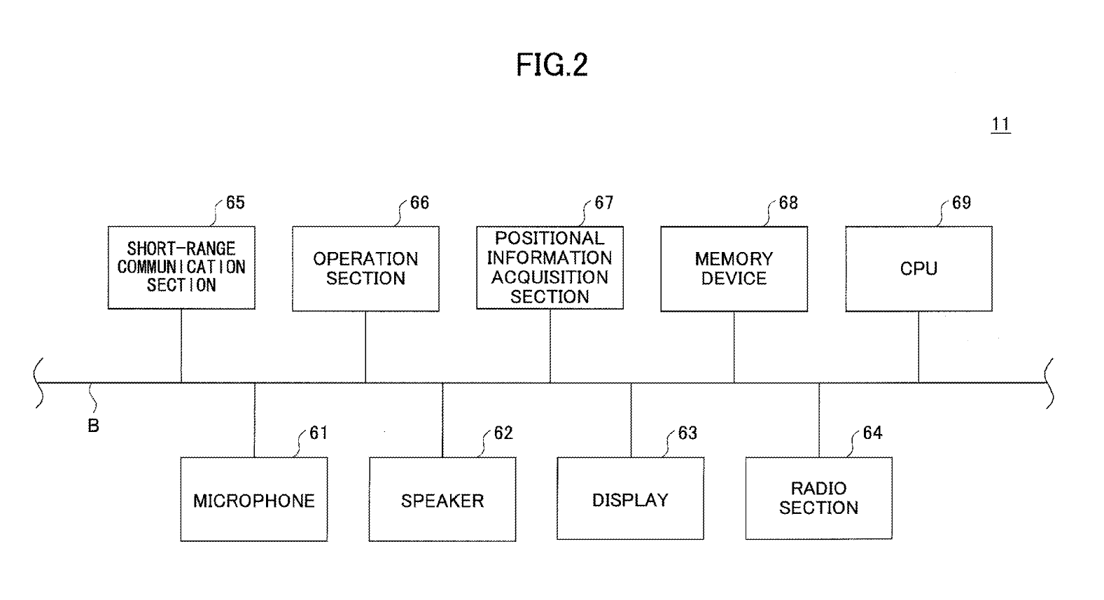

FIG. 2 illustrates an example hardware configuration of the request terminal 11. The request terminal 11 of FIG. 2 includes a microphone 61, a speaker 62, a display 63, a radio section 64, a short-range communication section 65, an operation section 66, a positional information acquisition section 67, a memory device 68, and a Central Processing Unit (CPU) 69, which are connected each other via a system bus B.

The microphone 61 inputs the voice of a user and other sounds. The speaker 62 outputs the voice of the other party in the call and the ringtone, etc. The display 63 displays various information such as time information, the information indicating whether out-of-service range or not, character data, and image data. The display 63 may be, for example, but not limited to, a Liquid Crystal Display (LCD).

The radio section 64 refers to a transmission and receiving section that receives a radio signal transmitted from a base station and the communication network 14 (“communication data”) and transmits such communication data.

The short-range communication section 65 is in short-range communication (“local communication”) with the home terminal 12 and another request terminal 11. For example, the short-range communication section 65 is in short-range communication with the home terminal 12 and another request terminal 11 via a relay apparatus such as a radio router, or an Access Point (AP).

The operation section 66 is an input unit to generate a request to receive a service, register a telephone number, and to be pressed by the user when requesting or receiving a call.

The positional information acquisition section 67 acquires positional information by using, for example, a GPS function. The method of acquiring the positional information by the positional information acquisition section 67 is not limited to the use of the GPS function. For example, the positional information may be acquired by using the positions of the base station and the relay apparatus.

The memory device 68 is a storage to store various information in the request terminal 11, and, for example, can write and read such information. The memory device 68 may be a Read-Only Memory (ROM), a Radom Access Memory (RAM) and the like. Here, the ROM stores, for example, a program to execute a process to receive a service according to this embodiment. The RAM stores, for example, various data to receive the service described above.

The CPU 69 calculates various data, and controls various processes in the request terminal 11 including data input and output to and from various hardware components based on a control program such as an Operating System (OS) and an execution program stored in the memory device 68. Further, the CPU 69 performs processing based on a program and an application stored in the memory device 68 in advance.

Specifically, the CPU 69 performs processes such as, for example, network monitoring by the network monitoring section 21, access processing by the access section 22, and service acquisition by the Push client 23. It should be noted that the processing content of the CPU 69 is not limited to those processes. The content executed by the CPU 69 is stored in the memory device 68 or the like when needed.

By having such a hardware configuration described above, it becomes possible for the request terminal 11 according to this embodiment to execute a process of a provided service. Further, it becomes possible for a computer to easily realize the process of the provided service by installing an execution program therein.

### Example Hardware Configuration of Home Terminal 12

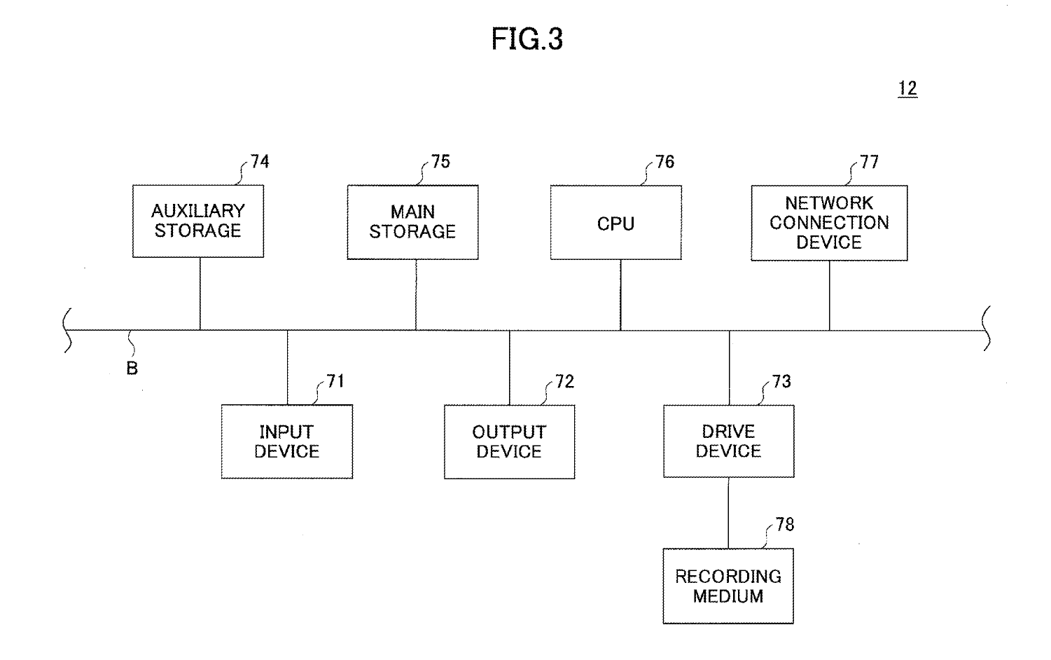

FIG. 3 illustrates an example hardware configuration of the home terminal 12. The home terminal 12 includes an input device 71, an output device 72, a drive device 73, an auxiliary storage device 74, a main storage device 75, a CPU 76, and a network connection device 77, which are connected to each other via a system bus B.

The input device 71 includes a keyboard and a pointing device such as a mouse, which are operated by a user or the like, and a voice input device such as a microphone, so as to receive, for example, an instruction to execute a program by the user or the like, various operational information, and information to start up software and the like.

The output device 72 includes a display that displays, for example, various windows and data to operate the computer main body (home terminal 12), which is for executing a process according to this embodiment, so as to display an execution process a program based on a control program of the CPU 76.

Here, the execution program to be stored in the computer main body in this embodiment may be provided by using, for example, a portable recording medium 78 such as a Universal Serial Bus (USB) memory, a CD-ROM, or a Digital Versatile Disk (DVD).

The recording medium 78 is mountable (settable) in the drive device 73, so that the execution program stored in the recording medium 78 is installed in the auxiliary storage device 74 via the drive device 73 based on the control signal from the CPU 76.

The auxiliary storage device 74 is a storage such as, for example, a Hard Disk Drive (HDD) or a Solid State Drive (SSD). The auxiliary storage device 74 stores, for example, the execution program according to this embodiment and the control program of the computer based on the control signal from the CPU 76, and inputs and outputs the programs when it is desired.

The auxiliary storage device 74 can read and write desired information from and to the stored information based on a control signal from the CPU 76 based on, for example, a control signal from the CPU 76.

The main storage device 75 stores the execution program which is read from the auxiliary storage device 74 by the CPU 76. The main storage device 75 may be, for example, a ROM or a RAM. The auxiliary storage device 74 and the main storage device 75 correspond to, for example, the storage section 45 described above.

The CPU 76 controls the whole process, which includes, for example, various calculations, data input and output to and from various hardware elements based on the control program of the OS or the like and the execution program stored in the main storage device 75 so as to realize various processes. During the execution of the program, the CPU 76 can acquire various desired information from the auxiliary storage device 74 and can store the execution results and the like.

Specifically, by executing a program installed in the auxiliary storage device 74 based on an instruction acquired from the input device 71 or the like to execute the program, the CPU 76 performs a process, which corresponds to the program, on the main storage device 75.

For example, by executing a service supply program, the CPU 76 executes the processes such as the service supply by the Push service 31, the reception of the process by the process receiving section 32, the execution of the service by the home service execution section 33, and the access proxy by the access proxy section 34.

It should be noted that the processes that can be executed by the CPU 76 are not limited to the processes described above. The content executed by the CPU 76 is stored in the auxiliary storage device 74 or the like when needed.

The network connection device 77 is in communication with the request terminal 11 and the Cloud 13 via the communication network 14. For example, the network connection device 77 acquires the execution program, software, and setting information from an external apparatus which is in connection with the network connection device 77 via the communication network 14 which is in connection with the network connection device 77 based on a control signal from the CPU 76.

Further, the network connection device 77 is able to provide the external apparatus or the like with an execution result acquired by executing the program and the execution program in this embodiment.

By having such a configuration described above, it becomes possible to execute a schedule management process according to this embodiment. Further, by installing the execution program that can execute the functions described above (“service supply program”) into the computer, it becomes possible for the computer such as a general-purpose computer to easily realize the service supply process according to this embodiment. Further, in a case where the Cloud 13 is a general-purpose PC or a server, a configuration similar to the above described configuration of the home terminal 12 may be applied.

Example of Service Supply when Request Terminal 11 is Used in Home Area 15

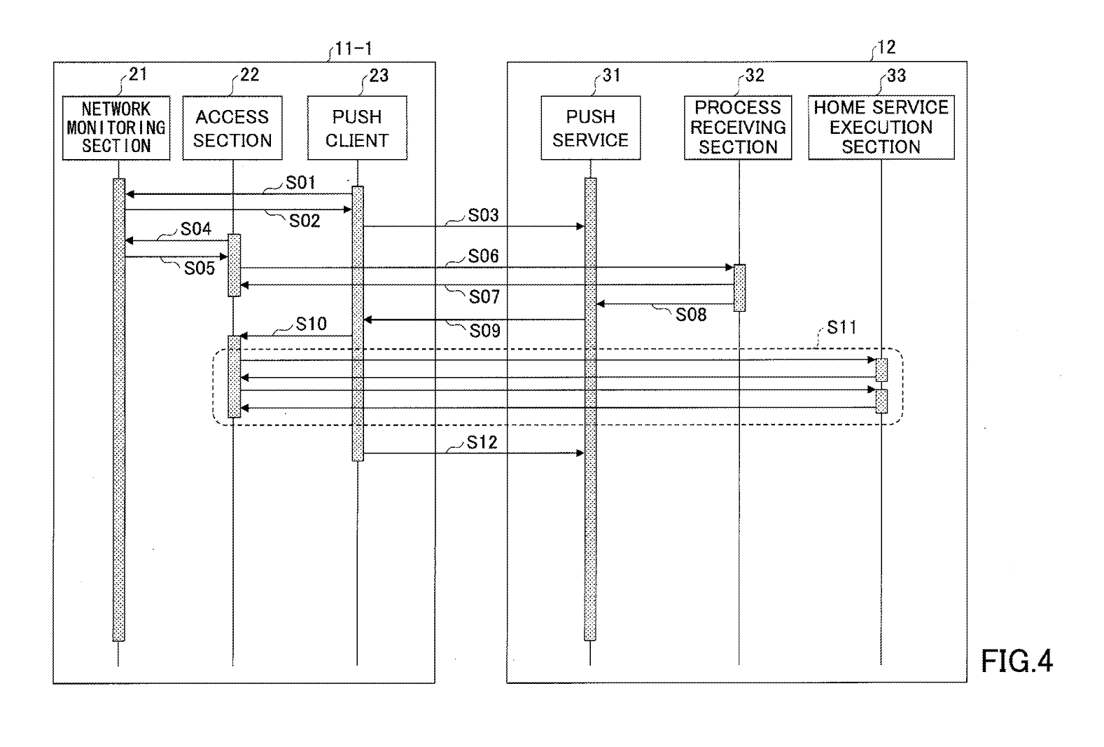

Next, an example of service supply when the request terminal 11 is used in the home area 15 is described with reference to the accompanying sequence diagram. FIG. 4 is a sequence diagram of an example service supply when the request terminal 11 is used in the home area 15. In the example of FIG. 4, the request terminal 11-1 in the home area 15 is in communication with the home terminal 12.

The request terminal 11-1 of FIG. 4 includes the network monitoring section 21, the access section 22, and the Push client 23. The home terminal 12 of FIG. 4 includes the Push service 31, the process receiving section 32, and the home service execution section 33.

In the example of FIG. 4, before accessing the home terminal 12, the Push client 23 sends a request for acquiring the contact destination to the network monitoring section 21 (step S01). In the example of FIG. 4, the Push client 23 receives a response indicating that the request terminal 11-1 is in the home area 15 (step S02).

In step S02, the Push client 23 may acquire the contact destination information of the home terminal 12 from the network monitoring section 21. The contact destination information corresponds to the in-home connection and is set in advance.

Next, the Push client 23 is in connection with the Push service 31 of the home terminal 12 (step S03). This connection is bi-directionally accessible, so that the Push service 31 can communicate with the Push client 23 at any timing. The communication may be done by using, for example, a network address (e.g., Socket) which is a combination of an IP address and a port number or a WebSocket. The communication, however, is not limited to this example.

Next, the access section 22 sends a request for acquiring the contact destination to the network monitoring section 21 (step S04), and receives a response indicating that the request terminal 11-1 is in the home area 15 (step S05). In step S05, the access section 22 may acquire the contact destination information of the home terminal 12 from the network monitoring section 21.

The contact destination information corresponds to the in-home connection and is set in advance. Next, the access section 22 sends a process request to the process receiving section 32 of the home terminal 12 (step S06).

The process receiving section 32 promptly responds to the access section 22 by, for example, sending a message indicating the acceptance of the process request from the access section 22 (step S07). Then, the process receiving section 32 requests for the service access notification to the Push service 31 (step S08).

The Push service 31 Pushes (transmits) the service access notification to the Push client 23 (step S09). The Push client 23 receives the service access notification from the Push service 31, and sends the access permission notification to the access section 22 (step S10).

Upon the receipt of the access permission notification, the access section 22 accesses the home service execution section 33 of the home terminal 12 (step S11). In the process of step S11, as illustrated in FIG. 4, data are transmitted and received one or more times depending on, for example, the content of the service between the access section 22 and the home service execution section 33

As described above, the request terminal 11-1 can asynchronously access the home service execution section 33 by using the Push transmission from the home terminal 12. Further, as the access permission notification from the Push client 23 to the access section 22 in step S10, a predetermined function call may be used when the access section 22 and the Push client 23 are based on the same application.

On the other hand, when the access section 22 and the Push client 23 are based on different applications, as the access permission notification, for example, a process-to-process communication may be used.

Further, the access permission notification may be done by using the Socket, the PIPE, the Websocket, and the Intent of Android (registered trademark). Here, the Intent refers to functions to, for example, notify an array, a character string, and an integer type to another application, and call another Activity.

Next, after completion of the service in the home terminal 12, the Push client 23 sends a terminate (cut) instruction to the Push service 31 (step S12) to terminate (cut) the process.

In the process of steps S01 and S04 described above, the Push client 23 and the access section 22 send the request for acquiring the contact destination to the network monitoring section 21. In this case, the address (e.g., URL) to be used when the access section 22 accesses the home service execution section 33 is notified by a Push notification.

Therefore, the acquisition request for acquiring the contact destination to the network monitoring section 21 is not sent before the access to the network monitoring section 21.

### Example Process in Network Monitoring Section 21

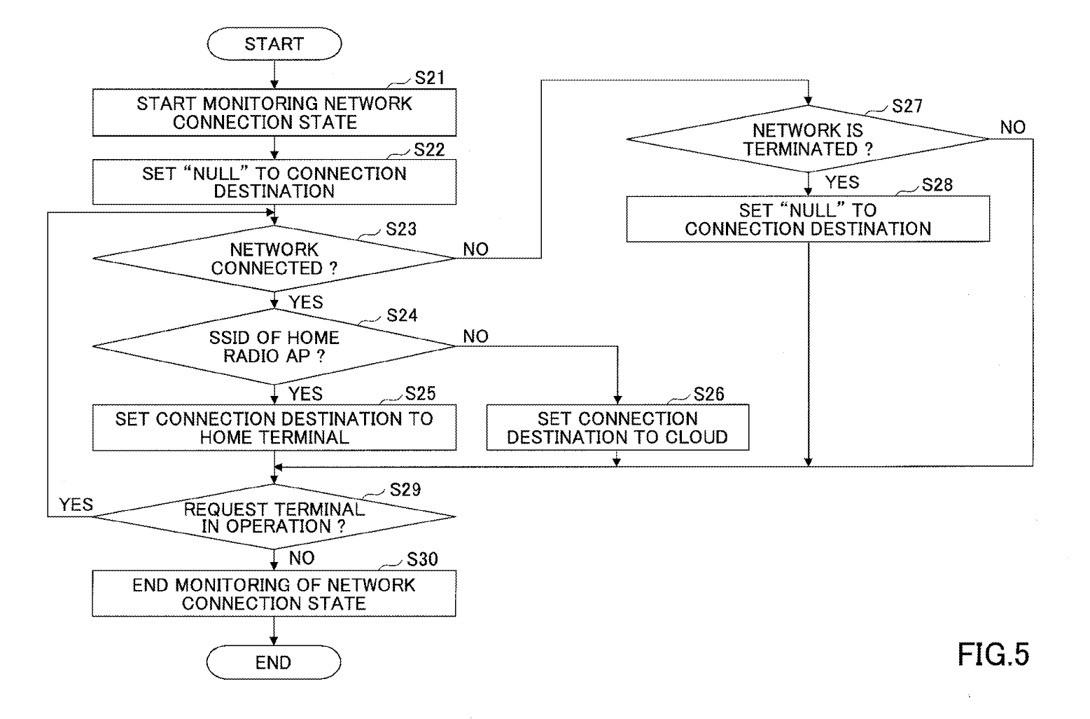

Next, an example process of the network monitoring section 21 is specifically described with reference to a flowchart. FIG. 5 is a flowchart of an example process of the network monitoring section 21. In the example network monitoring process of FIG. 5, it is assumed that the information indicating the home Service Set Identifier (SSID), the home terminal connection destination, and the Cloud contact destination are set in advance.

In the example of FIG. 5, the network monitoring section 21 starts monitoring of a network connection state (step S21). In the beginning, the request terminal 11 is not connected to another apparatus and the connection destination is empty (null).

Therefore, as the initial state, the value “null” is set to the home terminal connection destination and the Cloud connection destination (step S22). Next, the network monitoring section 21 determines whether the request terminal 11 is in network connection with another apparatus (step S23).

When determining that the request terminal 11 is in network connection with another apparatus (YES in step S23), the network monitoring section 21 further determines whether the address information of the apparatus corresponds to the SSID of the home wireless AP (e.g., Wi-Fi) which is set in advance (step S24). Here, the SSID refers to, for example, an identifier of the AP in a wireless LAN (IEEE802.11 series).

By checking the identifier, the network monitoring section 21 determines whether the request terminal 11 is in the home area 15. Then, based on the determination result, the home terminal 12 is set whether to access the home terminal 12 or to access the Cloud 13.

In this embodiment, a criterion other than the SSID may be used. For example, when the request terminal 11 includes the GPS function, the GPS function may be used to acquire the positional information of the request terminal 11, so as to determine whether the acquired positional information indicates the home area 15 which is set in advance.

By doing this, it becomes possible to determine (switch) the contact destination.

When determining that the address information in the network connection correspond to the SSID of the home wireless AP (YES in step S24), the network monitoring section 21 sets the home terminal 12 as the connection destination (step S25). On the other hand, when determining that the address information in the network connection does not correspond to the SSID of the home wireless AP (NO in step S24), the network monitoring section 21 sets the Cloud 13 as the connection destination (step S26).

Further, in the process of step S23, when determining that the request terminal 11 is not in network connection with another apparatus (NO in step S23), the network monitoring section 21 further determines whether the network is cut off (not available) (step S27). When determining that the network is cut off (not available) (YES in step S27), the network monitoring section 21 sets “null” to the contact destination of the home terminal 12 and the contact destination of the Cloud 13 (step S28).

When determining that the network is not cut off (available) (NO in step S27), the network monitoring section 21 further determines whether the request terminal 11 is in operation (step S29). The network monitoring section 21 executes the process of step S29 after any of the processes of steps S25, S26, and S28.

In the process of step S29, the determination is made whether the request terminal 11 is in operation to terminate the network monitoring process due to, for example, shutdown of the request terminal 11 and to repeat the processes described above when the request terminal 11 is in operation.

Namely, when determining that the request terminal 11 is in operation (YES in step S29), the process of the network monitoring section 21 goes back to step S23. On the other hand, when determining that the request terminal 11 is not in operation (NO in step S29), the network monitoring section 21 ends the monitoring (step S30), and terminates the process.

By executing the processes described above, when the connection state is changed, the network monitoring section 21 determines whether the connection state corresponds to in-home or out-of-home, and can set the connection destination based on the determination result.

Therefore, when receiving the request to acquire the current connection destination from the access section 22 and the Push client 23, the network monitoring section 21 can respond to the request based on the connecting destination which has been acquired by the above monitoring process.

Further, the network monitoring section 21 may execute the above process upon receiving the acquisition request from the access section 22 or the Push client 23, so as to respond to the request with result of the execution.

### Example Data in Network Monitoring

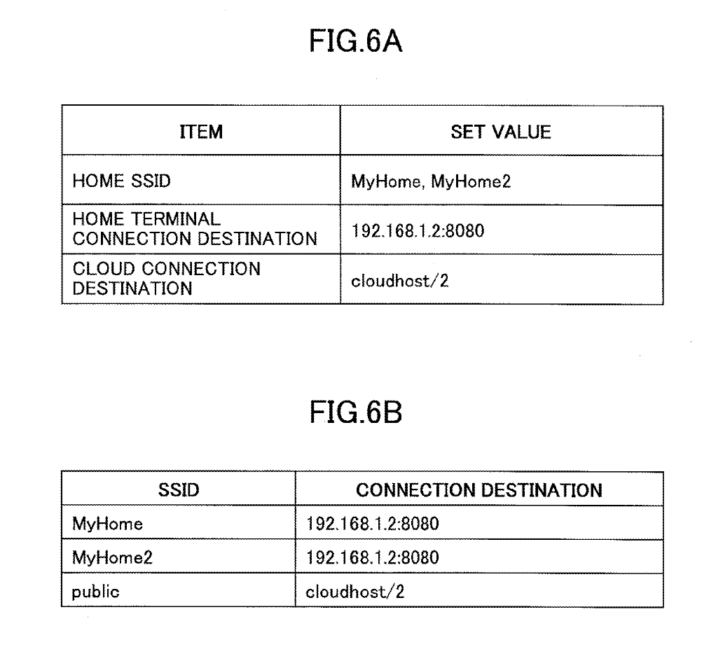

Next, example data in the above network monitoring are described with reference to the drawings. FIGS. 6A and 6B illustrate example data in the network monitoring. FIG. 6A illustrates example information to determine the connection destination, and FIG. 6B illustrates connection destination information based on the SSID value described above.

In the example of FIG. 6A, the “item” and the corresponding “set value” are described. Here, the value “MyHome, MyHome2” is set to the item “home SSID”, the value “192.168.1.2:8080” is set to the item “home terminal connection destination”, and the value “cloudhost/2” is set to the item “cloud connection destination”. Here, the “home SSID” refers to, for example, the SSID of the home wireless AP (e.g., Wi-Fi) which covers the home area (which enables wireless communications in the home area 15).

Further, in this embodiment, it is possible to set more than one “set value” for one “item”. For example, two set values “MyHome” and “MyHome2” are set relative to the item “home SSID”.

The example of FIG. 6B illustrates how the “connection destination” is determined relative to the “SSID” in the network connection. Specifically, in the example of FIG. 6B, when the “SSID” is “MyHome” or “MyHome2”, the “connection destination” is determined to be “192.168.1.2:8080”. Further, when the “SSID” is “public”, the “connection destination” is determined to be “cloudhost/2”. Namely, when the “SSID” is “MyHome” or “MyHome2”, the home terminal 12 is set as the connection destination, and when the “SSID” is “public”, the Cloud 13 is set as the connection destination.

By doing this, it becomes possible to set an appropriate connection destination when the request terminal 11 receives the home service in this embodiment supplied from the home terminal 12. Here, the “set value” described above may be stored in, for example, an internal memory of the network monitoring section 21 or a storage section of the request terminal 11.

Further, in another example of the “connection destination” to be set, the positional information of the request terminal 11 is acquired by using the GPS function etc., and when it is determined that the positional information indicates that the request terminal 12 is in the home area 15, the home terminal 12 may be set as the connection destination, and when it is determined that the positional information indicates that the request terminal 12 is out of the home area 15, the Cloud 13 may be set as the connection destination.

### Example Process of Push Client 23

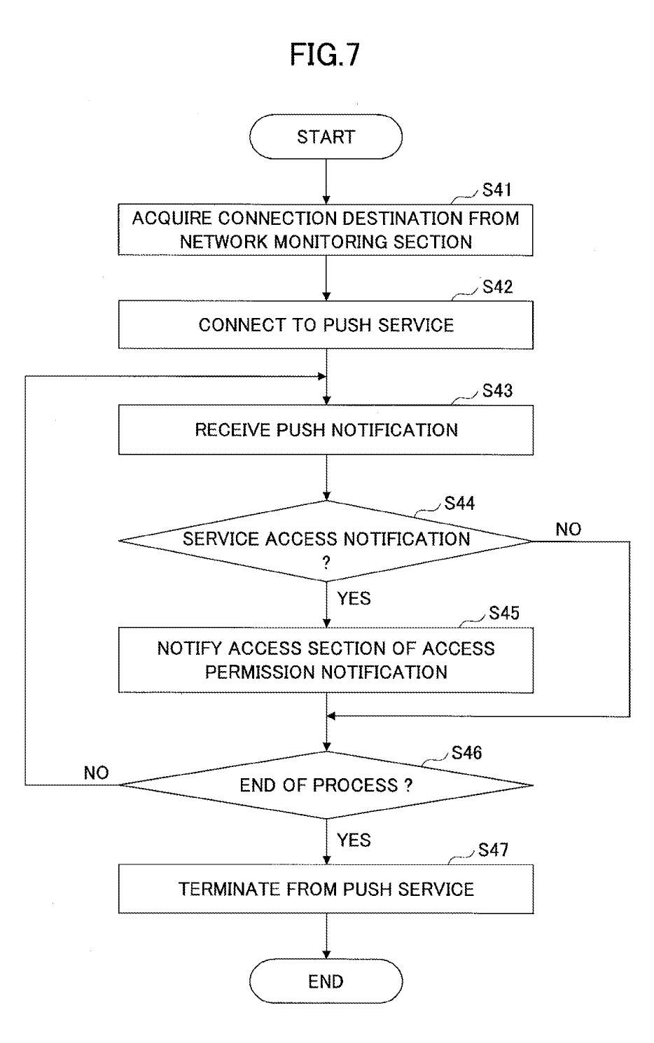

Next, an example process of the Push client 23 is described with reference to a flowchart. FIG. 7 is a flowchart of an example process of the Push client 23. In the example of FIG. 7, the Push client 23 sends a request for acquiring the connection destination to the network monitoring section 21 and acquires the current connection destination (step S41). In the example of FIG. 7, it is assumed that the request terminal 11 is in the home area 15. Therefore, the Push client 23 acquires the information of the home terminal 12 as the information of the connection destination. As a result, the Push client 23 connects to (is in communication with) the Push service 31 of the home terminal 12 (step S42).

Next, the Push client 23 receives the Push notification from the Push service 31 (step S43), and determines whether the received content indicates the service access notification (step S44). When determining that the received content indicates the service access notification (YES in step S44), the Push client 23 transmits the access permission notification to the access section 22 (step S45).

Further, when determining that the received content does not indicate the service access notification (NO in step S44) or after the process of step S45, the Push client 23 determines whether the process is to be terminated (step S46).

In the process of step S46, it is assumed that the Push client 23 determines that the process is to be completed when, for example, shutdown is requested by the user or the connection with the Push service 31 is terminated. Further, it is assumed that, basically, the Push client 23 waits for the Push notification without being terminated.

When the Push client 23 does not terminate the process (NO in step S46), the process goes back to the process of step S43. On the other hand, when the Push client 23 determines that the process is to be terminated (YES in step S46), the Push client 23 terminates the Push service 31 first (step S47), and terminates the process.

Even when the Push client 23 is terminated due to switching of the network connection, it becomes possible to realize the switching between the home terminal 12 and the Cloud 13 by making it possible to start the Push client 23 again upon the connection to another network.

### Example Process of Push Service 31

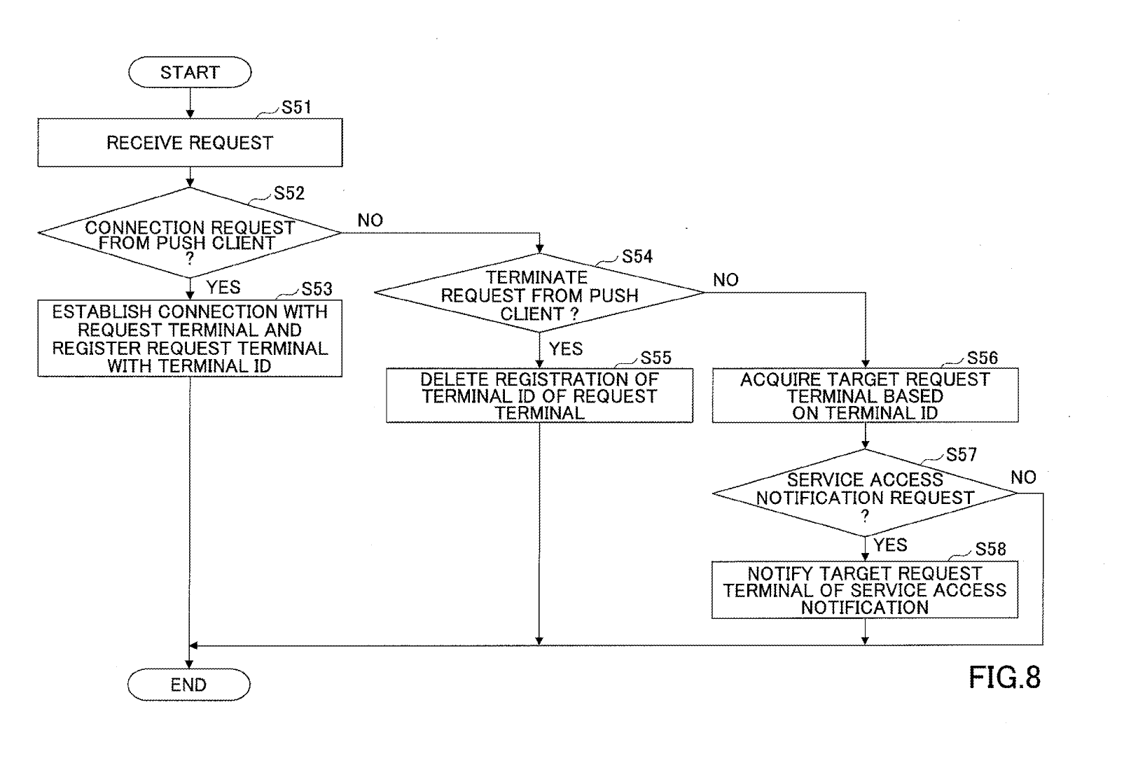

Next, an example process of the Push service 31 in the home terminal 12 is described with reference to a flowchart. FIG. 8 is a flowchart of an example process of the Push service 31. In the example of FIG. 8, the Push service 31 receives a request for the service supply (step S51), and determines whether the received request is a connection request from the Push client 23 (step S52).

When determining that the received request is the connection request from the Push client 23 (YES in step S52), the Push service 31 establishes the connection with the request terminal 11, and registers the request terminal 11 by using the terminal ID that identifies the request terminal 11 (step S53). Here, the terminal ID may be acquired upon the reception of the request in step S51.

On the other hand, when determining that the received request is not the connection request from the request terminal 11 (NO in step S52), the Push service 31 further determines whether the received request is the terminate request from the Push client 23 (step S54).

When determining that the received request is the terminate request from the Push client 23 (YES in step S54), the Push client 23 deletes the registration of the request terminal 11 of the corresponding terminal ID (step S55).

On the other hand, when determining that the received request is not the terminate request from the Push client 23 (NO in step S54), the Push client 23 acquires the target request terminal based on the terminal ID (step S56). Next, the Push client 23 further determines whether the received request is the request for the service access notification from the process receiving section 32 (step S57).

When determining that the received request is the request for the service access notification from the process receiving section 32 (YES in step S57), the Push client 23 sends the service access notification to the target request terminal 11 (step S58).

On the other hand, when determining that the received request is not the request for the service access notification (NO in step S57), the Push client 23 directly terminates the process. In this case, the Push client 23 may terminate the process after outputting an error message or the like.

### Example Process of Process Receiving Section 32

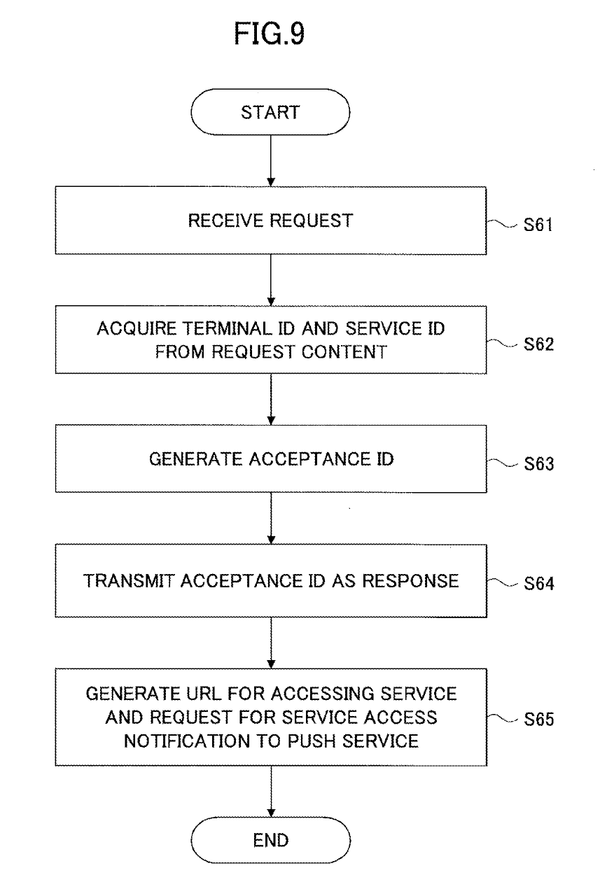

Next, an example process of the process receiving section 32 is described with reference to a flowchart. FIG. 9 is a flowchart of an example process of the process receiving section 32. In the example of FIG. 9, the process receiving section 32 receives the request from the access section 22 (step S61), and acquires the terminal ID and a service ID based on the received request content (step S62). Next, the process receiving section 32 generates an acceptance ID (step S63), and transmits the acceptance ID to the request terminal 11 as the response (step S64).

Next, the process receiving section 32 generates the URL so that the request terminal 11 accesses a predetermined service, and sends a request for the service access notification to the Push service 31 (step S65). In the process of step S65, the process receiving section 32 may set another address information in place of the URL as the information for accessing the predetermined service.

Further, the process receiving section 32 sends for the service access notification to the Push service 31 by using, for example, but not limited to, the terminal ID, the service ID, the acceptance ID, and the URL as the arguments.

### Example Data in Home Use

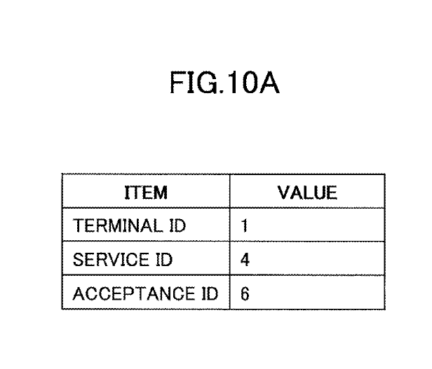

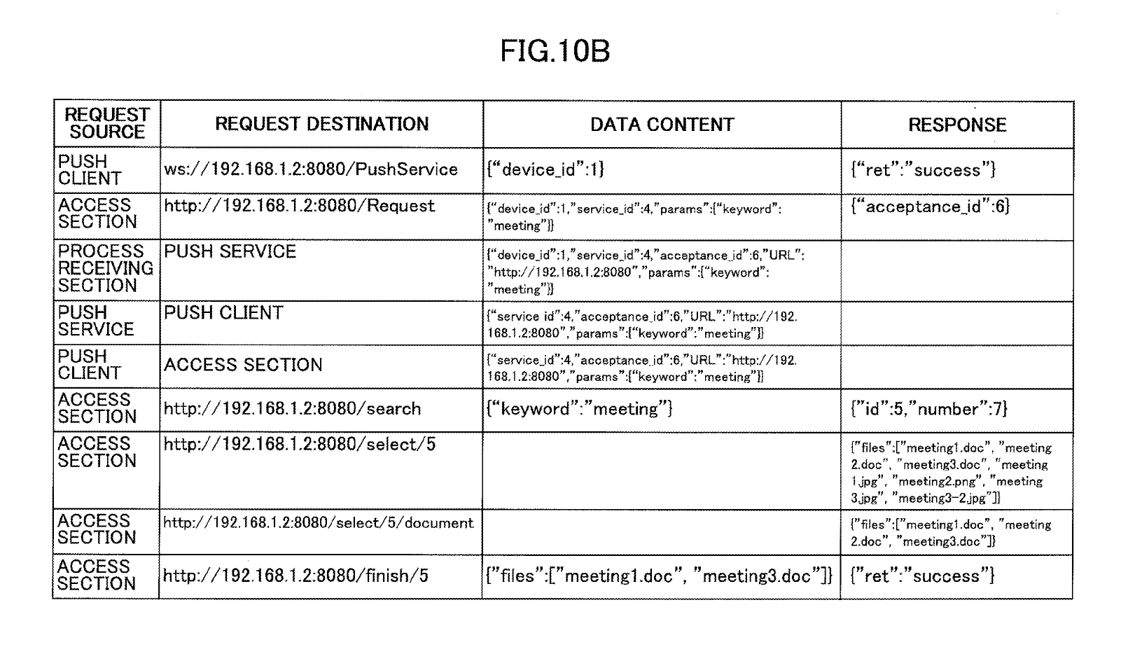

Next, example data when the service to be used is supplied in the home area 15 are described with reference to the drawings. FIGS. 10A and 10B are drawings illustrating example data in home use. FIG. 10A illustrates an example of set information (values) corresponding to items used in the services supplied in the embodiment. FIG. 10B illustrates an example service in home use.

The example of FIG. 10A includes the items and the corresponding values. However, the present invention is not limited to this combination. In the example of FIG. 10A the values of the “terminal ID (device_id)”, the “service ID (service_id)”, and the “acceptance ID (acceptance_id)) are set to “1”, “4”, and “6”, respectively. However, the values are not limited to those values.

In this embodiment, by using these values, as illustrated in the example of FIG. 10B, the request source and the request destination communicate with each other to transmit data content and receive the response, so as to execute the predetermined service.

The example of FIG. 10B illustrates a case where the request source “Push client 23” sends a request to the request destination “ws://192.168.1.2:8080/PushService” based on the WebSocket connection. Further, the example of FIG. 10B illustrates a case where all the data are transmitted and received by using the JavaScript Object Notation (JSON). However, this is an example only and the present invention is not limited to this configuration.

In the example of FIG. 10B, the request terminal 11 searches the home terminal 12 by using a search key word “meeting”, and acquires seven file lists as the search result. Further, in the example of FIG. 10B, only the document is selected from the acquired seven file lists, so that three document files are acquired.

Further, based on, for example, the user's instructions, two files are further selected. However, the supply of the home service is not limited to the content of the above case. Example of service supply to request terminal 11 in out-of-home use.

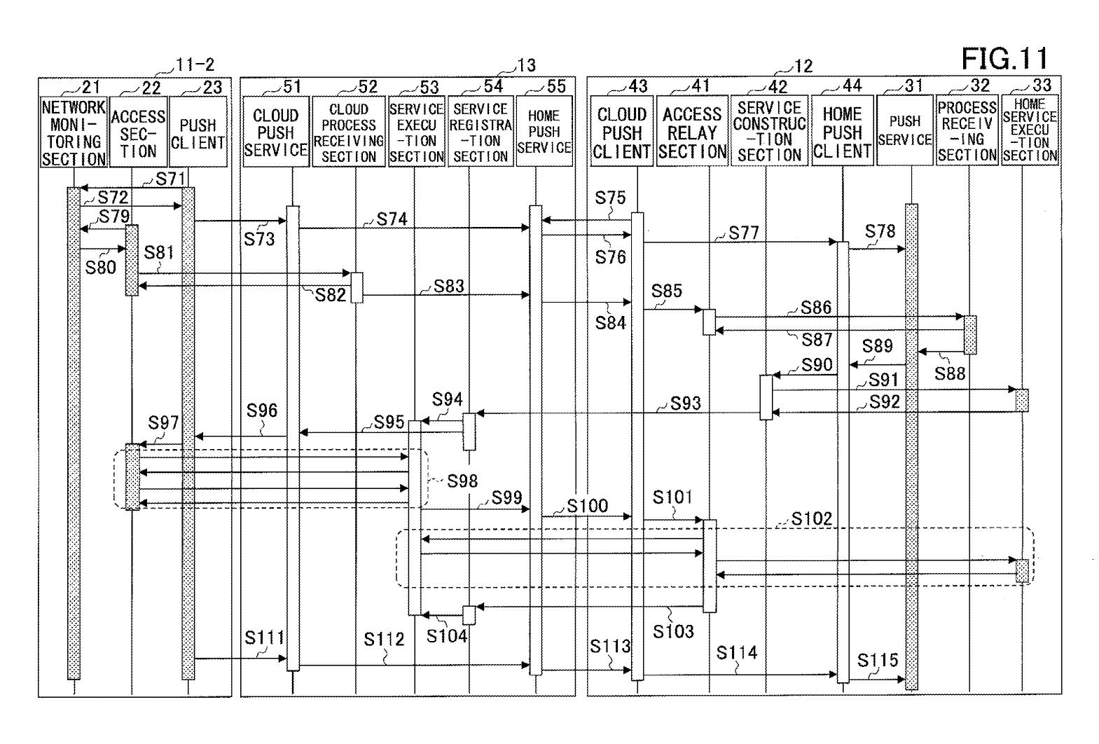

Next, an example of service supply in the request terminal 11 in out-of-home use is described with reference to a sequence diagram. FIG. 11 is a sequence diagram illustrating an example of service use in out-of-home use. The example of FIG. 11, illustrates the request terminal 11-2, the home terminal 12, and the Cloud 13.

The request terminal 11-2 includes the network monitoring section 21, the access section 22, and the Push client 23. The home terminal 12 includes the Cloud Push client 43, the access relay section 41, the service construction section 42, the home Push client 44, the Push service 31, the process receiving section 32, and the home service execution section 33.

Here, the access relay section 41, the service construction section 42, the Cloud Push client 43, and the home Push client 44 are included in the access proxy section 34. The Cloud 13 includes the Cloud Push service 51, the Cloud process receiving section 52, the service execution section 53, the service registration section 54, and the home Push service 55.

In the example of FIG. 11, before the access to the home terminal 12 (in the case of FIG. 11, before the access to the Cloud 13 to use the service of the home terminal 12), the Push client 23 sends a request for acquiring the connection destination to the network monitoring section 21 (step S71).

In the example of FIG. 11, the Push client 23 receives that response from the network monitoring section 21, the response indicating that the request terminal is in the out-of-home area (e.g., the response includes the connection destination information of the Cloud 13) (step S72). In the process of step S72, the Push client 23 may acquire the connection destination information of the Cloud 13 which is set in advance, so as to correspond to the connection in out-of-home use (connection).

Next, the Push client 23 of the request terminal 11-2 is in connection with the Cloud Push service 51 of the Cloud 13 (step S73). The Cloud Push service 51 sends a request for a terminal connection notification to the home Push service 55 (step S74). At this point, the Cloud Push client 43 of the home terminal 12 is already in connection with the home Push service 55 of the Cloud 13 (step S75).

The home Push service 55 transmits the connection notification to the Cloud Push client 43 (step S76). The Cloud Push client 43 generates the home Push client 44 (step S77), and the home Push client 44 is in connection with the Push service 31 (step S78). By doing this, the request terminal 11 is ready for the asynchronous access to the home service.

Next, the access section 22 sends the acquisition request for acquiring the contact destination to the network monitoring section 21 (step S79). In the example of FIG. 11, the access section 22 receives the information indicating that the request terminal 11-2 is in the out-of-home area (step S80).

Here, in the process of step S80, the access section 22 may acquire the connection destination information of the Cloud 13 which is set in advance, so as to correspond to the connection in out-of-home connection. Next, the access section 22 sends the process request to the Cloud process receiving section 52 of the Cloud 13 (step S81).

The Cloud process receiving section 52 promptly responds to the access section 22, informing the acceptance of the process request from the access section 22 (step S82). Next, the Cloud process receiving section 52 requests for sending the process request to the home Push service 55 (step S83). The home Push service 55 notifies the process request to the Cloud Push client 43 of the home terminal 12 (step S84).

The Cloud Push client 43 outputs the process request to the access relay section 41 (step S85). The access relay section 41 outputs the received process request to the process receiving section 32 (step S86). The process receiving section 32 promptly respond to the access relay section 41, informing the acceptance of the process from the access relay section 41 (step S87). Next, the process receiving section 32 requests for the service access notification to the Push service 31 (step S88).

The Push service 31 sends the service access notification to the home Push client 44 (step S89). The home Push client 44 sends the service access notification to the service construction section 42 (step S90).

The service construction section 42 accesses the home service execution section 33 (step S91), and receives the response from the home service execution section 33 (step S92). Further, in order to construct the service in the Cloud 13, the service construction section 42 registers the service in the service registration section 54 of the Cloud 13 (step S93).

The service registration section 54 of the Cloud 13 registers the service, which is acquired from the service construction section 42, in the service execution section 53, and, upon the completion of the registration, requests for starting the service registered in the service execution section 53 (step S94). Further, the service registration section 54 sends a request for the service access notification to the Cloud Push service 51 (step S95).

The Cloud Push service 51 sends the service access notification to the Push client 23 of the request terminal 11-2 (step S96). The Push client 23 sends the service access notification to the access section 22 (step S97).

Here, the access section 22 accesses the service of the service execution section 53 (home service), the service being constructed in the Cloud (step S98). Further, in the process of step S98, one or more services may be used. Therefore, data may be transmitted and received one or more times between the access section 22 and the service execution section 53.

Here, when the access to the predetermined service is completed, the service execution section 53 requests for the access termination notification to the home Push service 55 (step S99). Next, the home Push service 55 sends the access termination notification to the Cloud Push client 43 (step S100), and the Cloud Push client 43 sends the access termination notification to the access relay section (step S101).

In a case where the use of the service by the request terminal 11 influences the home service, the access relay section 41 accesses the service which is constructed in the Cloud 13 (i.e., the service execution section 53) and the home service execution section 33 so as to reflect the content, which is executed by the Cloud 13, on the home service execution section 33 (step S102).

Here, in the process of step S102, when there is information about a new registration, updates and the like in addition to the acquisition of information from the service, the information is acquired from the Cloud 13 and is registered into the home service execution section 33. Further, when the access relay section 41 just refers to the information from the service, the process of step S102 may be skipped.

Next, the access relay section 41 requests for deleting the service to the service registration section 54 (step S103). The service registration section 54 deletes the service (step S104). By doing this, the registered service is not maintained in the Cloud 13, so as to avoid (reduce the risk of), for example, unauthorized access and information leakage.

Here, the sequence diagram of FIG. 11 illustrates a case where the request terminal 11 cuts the communications after using the service. In this case, the Push client 23 of the request terminal 11 terminates the connection to the Cloud Push service 51 (step S111). The Cloud Push service 51 requests for the terminate notification to the home Push service 55 (step S112). Next, the home Push service 55 sends the terminate notification to the Cloud Push client 43 of the home terminal 12 (step S113).

Next, the Cloud Push client 43 notifies the home Push client 44 of the termination (step S114). Next, the home Push client 44 terminates the connection to the Push service 31 to terminate the home Push client 44 (step S115).

By the process of FIG. 11, when the request terminal 11 is in the out-of-home area, by using the Cloud 13 alone, it becomes possible to execute the process of the request terminal 11 and the processes of the Push service 31, the process receiving section 32, and the home service execution section 33 of the home terminal 12 (dotted areas in FIG. 11) on the Cloud 13 side without changing the processes. Further, in the above example, only the result of the execution of the home service based on the sequence is constructed on the Cloud 13.

Namely, not all the information stored in the home terminal 12 is constructed on the Cloud 13. Further, in the above example, the service is deleted when the provided service is terminated. Therefore, it becomes possible to avoid (reduce the risk of), for example, the unauthorized access and the information leakage and provide an appropriate service with improved security.

Next, a specific example of the configurations in the out-of-home use is described. In the following, the descriptions of the configurations that execute the processes similar to those in the home use are omitted.

### Example Process of Cloud Push Client 43

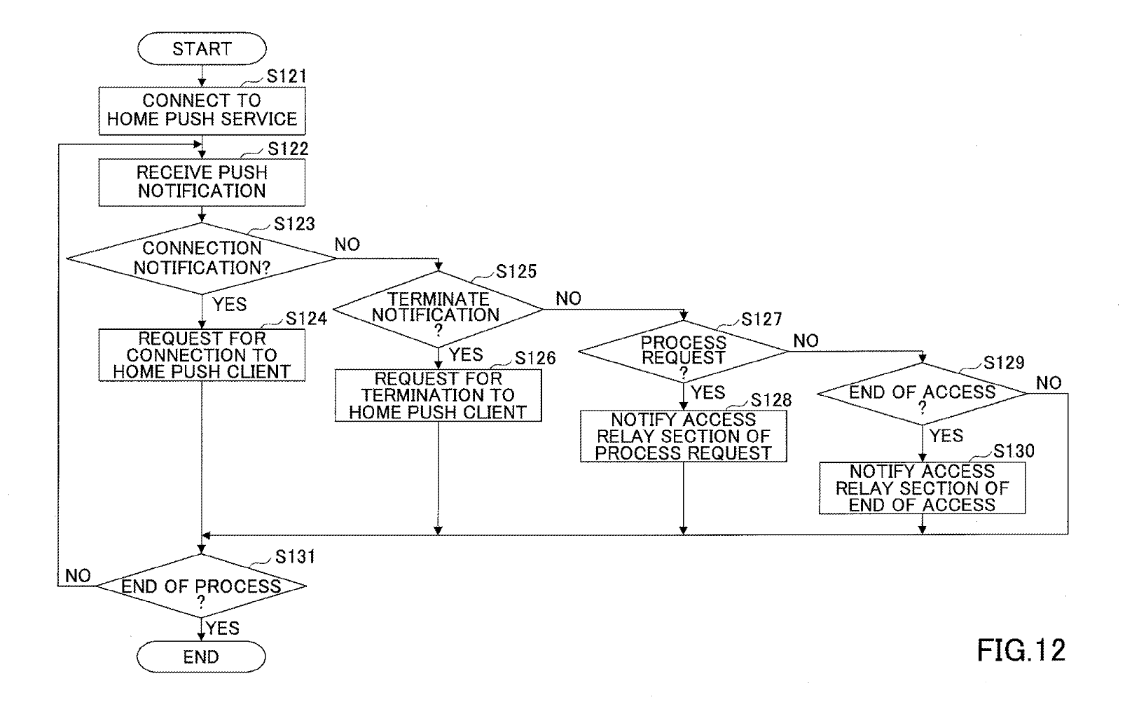

Next, an example process of the Cloud Push client 43 in the access proxy section 34 of the home terminal 12 is described with reference to a flowchart. FIG. 12 is a flowchart of an example process of the Cloud Push client 43.

In the example of FIG. 12, the Cloud Push client 43 is in connection with the home Push service 55 of the Cloud 13 (step S121), and is in a wait state to wait for receiving the Push notification. Then, the Cloud Push client 43 receives the Push notification from the home Push service 55 (step S122). Next, the Cloud Push client 43 determines whether the received notification is the connection notification (step S123). When determining that the received notification is the connection notification (YES in step S123), the Cloud Push client 43 requests for the connection to the home Push client 44 (step S124).

Further, when determining that the received notification is not the connection notification (NO in step S123), the Cloud Push client 43 further determines whether the received notification is the terminate notification (step S125). When determining that the received notification is the terminate notification (YES in step S125), the Cloud Push client 43 requests for terminating to the home Push client 44 (step S126).

On the other hand, when determining that the received notification is not the terminate notification (NO in step S125), the Cloud Push client 43 further determines whether the received notification is the process request (step S127). When determining that the received notification is the process request (YES in step S127), the Cloud Push client 43 sends the process request to the access relay section 41 (step S128).

On the other hand, when determining that the received notification is not the process request (NO in step S127), the Cloud Push client 43 determines whether the access is to be terminated (step S129). When determining that the access is to be terminated (YES in step S129), the Cloud Push client 43 notifies the access relay section 41 of the access termination (step S130).

On the other hand, after one of the processes of steps S124, S126, S128, and S130 or when determining that the access is not to be terminated (NO in step S129), the Cloud Push client 43 further determines whether the process is to be terminated (step S131). When determining that the process is not to be terminated (NO in step S131), the process goes back to the process of step S122.

On the other hand, when determining that the process is to be terminated (YES in step S131), the Cloud Push client 43 terminates the process of the Cloud Push client 43.

### Example Process of Home Push Client 44

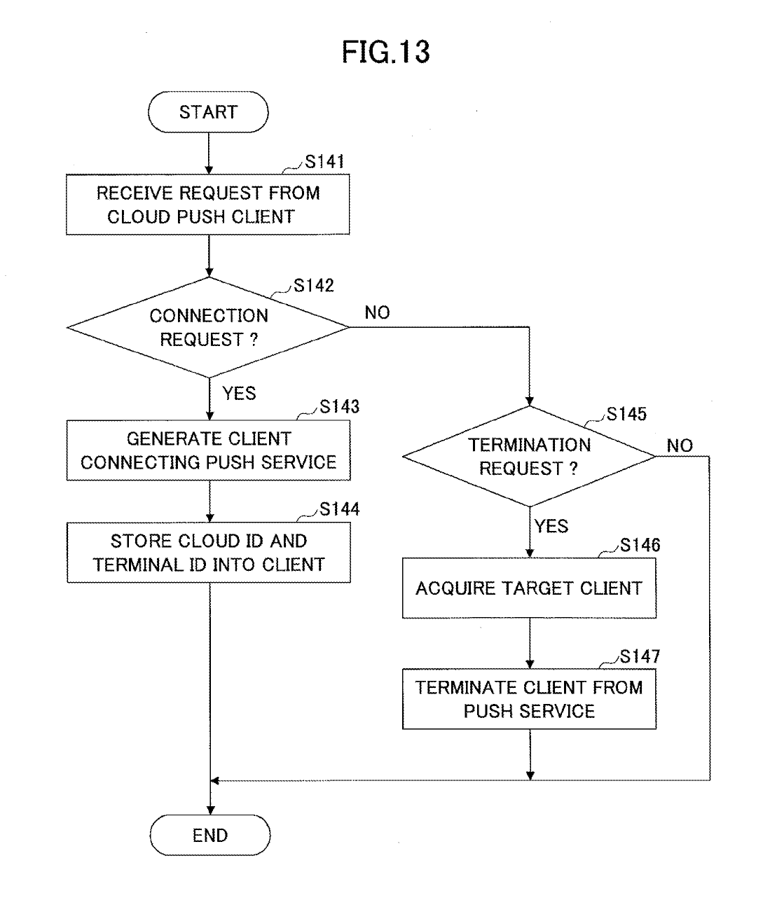

Next, an example process of the home Push client 44 in the access proxy section 34 of the home terminal 12 is described with reference to a flowchart. FIG. 13 is a flowchart of an example process of a connection control process of the home Push client 44.

In the example of FIG. 13, the home Push client 44 receives a request from the Cloud Push client 43 (step S141), and determines whether the received request is the connection request to the Push service 31 (step S142).

When determining that the received request is the connection request (YES in step S142), the home Push client 44 generates a client to be connected to the Push service 31 (step S143), and stores the Cloud ID and the terminal ID in association with the generated client (step S144). Namely, in the process of step S143, for example, the home Push client 44 generates clients that access by proxy the respective Cloud ID and the terminal ID.

On the other hand, when determining that the received request is not the connection request (NO in step S142), the home Push client 44 further determines whether the received request is the terminate request of the Push service 31 (step S145). When determining that the received request is the cut request (YES in step S145), the home Push client 44 acquires the target client (step S146), and terminates the target client from the Push service (step S147).

On the other hand, when determining that the received request is not the terminate request (NO in step S145), the home Push client 44 may terminate the process or may output an error message.

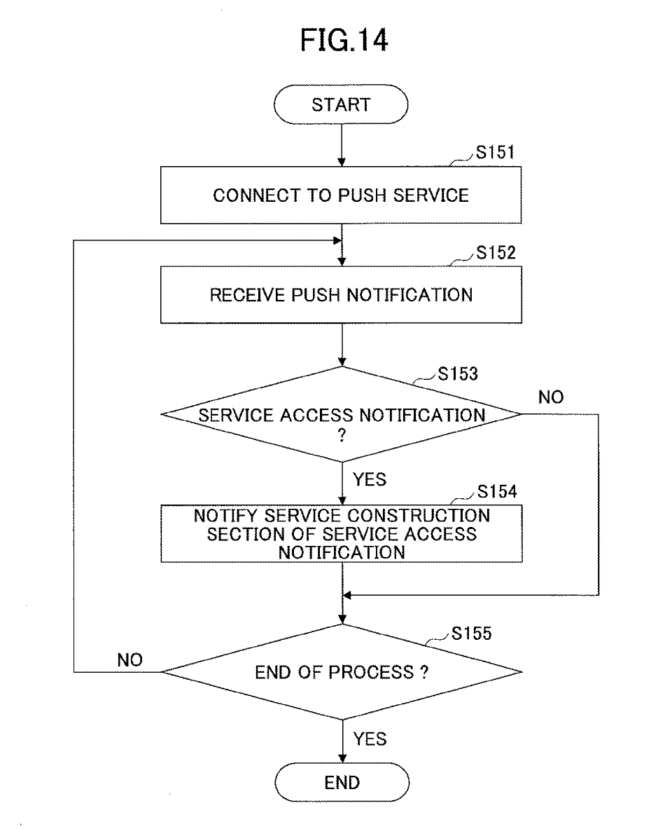

FIG. 14 is a flowchart of an example process of the generated client. In the example of FIG. 14, the client generated by the home Push client 44 is in connection with the Push service 31 (step S151), and is in a wait state to wait for the Push notification. Then, the client receives the Push notification from the process receiving section (step S152). Next, the client determines whether the received notification is the service access notification (step S153). When determining that the received notification is the service access notification (YES in step S153), the client sends the service access notification to the service construction section 42 (step S154).

On the other hand, after the process of step S154 or when determining that the received notification is not the service access notification (NO in step S153), the client further determines whether the process is to be terminated (step S155).

When determining that the process is not to be terminated (NO in step S155), the process goes back to the process of step S152. On the other hand, when determining that the process is to be terminated (YES in step S155), the client terminates the process of the client.

Here, in the termination check process in step S155, it is determined whether the client is terminated by, for example, connection terminating. In the example of FIG. 14, the process of step S155 is executed after the notice is received. However, the connection termination may be done during waiting for the notification. Therefore, it should be noted that the timing of checking the termination is not limited to the timing described above.

In the connection control of FIG. 13, upon the connection notification, the home Push client 44 is generated, and upon the terminate notification, the home Push client 44 is terminated. Upon the termination, the client terminates the client. Therefore, in the connection control, only the termination is done.

Herein, upon the connection, the Cloud ID and the terminal ID area stored in the client. Therefore, in the process of the client in the example of FIG. 14, when the service access notification is sent to the service construction section 42, the Cloud ID and the terminal ID are added to the notification so as to be notified.

### Example Process of Access Relay Section 41

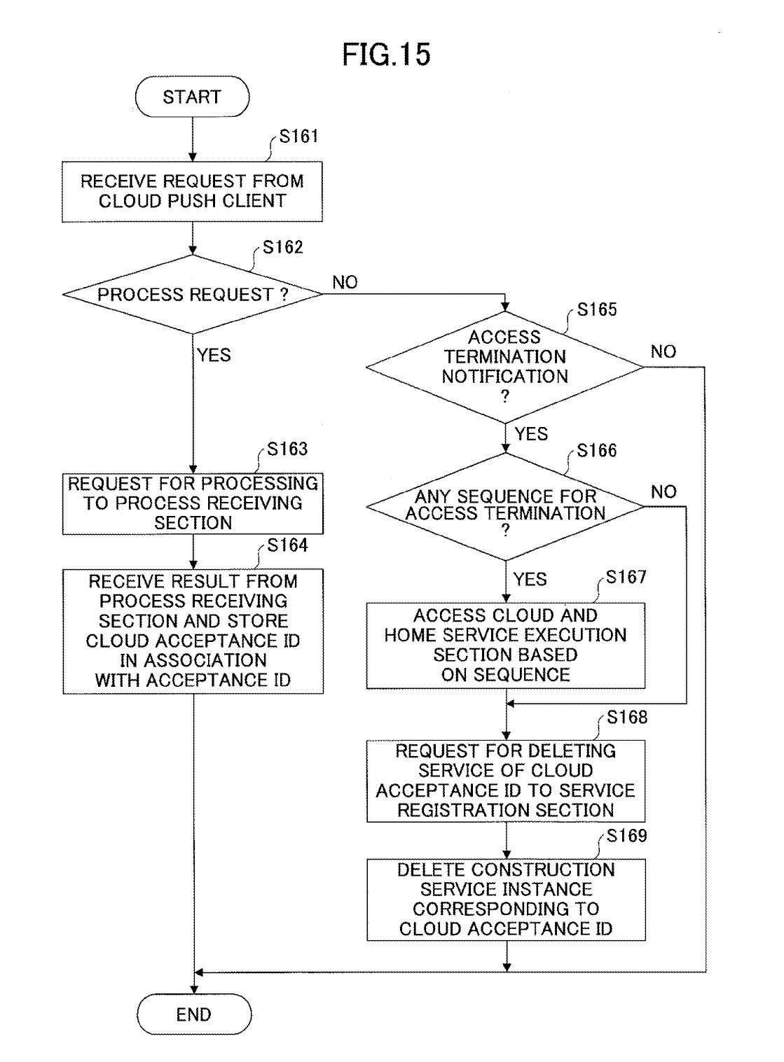

Next, an example process of the access relay section 41 in the access proxy section 34 of the home terminal is described with reference to a flowchart. FIG. 15 is a flowchart of an example process of the access relay section 41.

In the example of FIG. 15, the access relay section 41 receives a request from the Cloud Push client 43 (step S161), and determines whether the received request is the process request (step S162). When determining that the received request is the process request (YES in step S162), the access relay section 41 requests for the process to the process receiving section 32 (step S163).

Further, the access relay section 41 receives a result from the process receiving section 32, and stores the Cloud acceptance ID in association with the acceptance ID in the construction service instance 45-2 (step S164). The stored in formation is used in the service construction section 42 when the acceptance ID is converted into the Cloud acceptance ID.

On the other hand, when determining that the received request is not the process request (NO in step S162), the access relay section 41 determines whether the received request is the access termination notification (step S165). When determining that the received request is the access termination notification (YES in step S165), the access relay section 41 searches the service use sequence 45-1 and determines whether there is an access termination sequence (step S166).

In the process of step S166, the access relay section 41 determines, for example, whether there is a relay sequence corresponding to the service ID.

When determining that there is the access termination sequence (YES in step S166), the access relay section 41 accesses the Cloud 13 and the home service execution section 33 based on the access termination sequence (step S167). A specific example in the process of step S167 is described below.

On the other hand, when determining that there is no access termination sequence (NO in step S166), there is no relay sequence corresponding to the service ID. Therefore, the access relay section 41 does not access in accordance with the sequence.

Next, after the process of step S167 or when determining that there is no access termination sequence (NO in step S166), the access relay section 41 requests for deleting the service of the Cloud acceptance ID to the service registration section 54 (step S168).

Then, the access relay section 41 deletes the construction service instance 45-2 corresponding to the Cloud acceptance ID (step S169). Here, in the process of step S169, the access relay section 41 deletes, for example, the pair of acceptance ID and the Cloud acceptance ID included in the construction service instance 45-2 and the response when the access relay section 41 and the service construction section 42 access the service.

After one of the processes in steps S164 and S169 is done or when determining that the received request is not the access termination notification (NO in step S165), the access relay section 41 terminates the process.

### Specific Example Process in Step S167

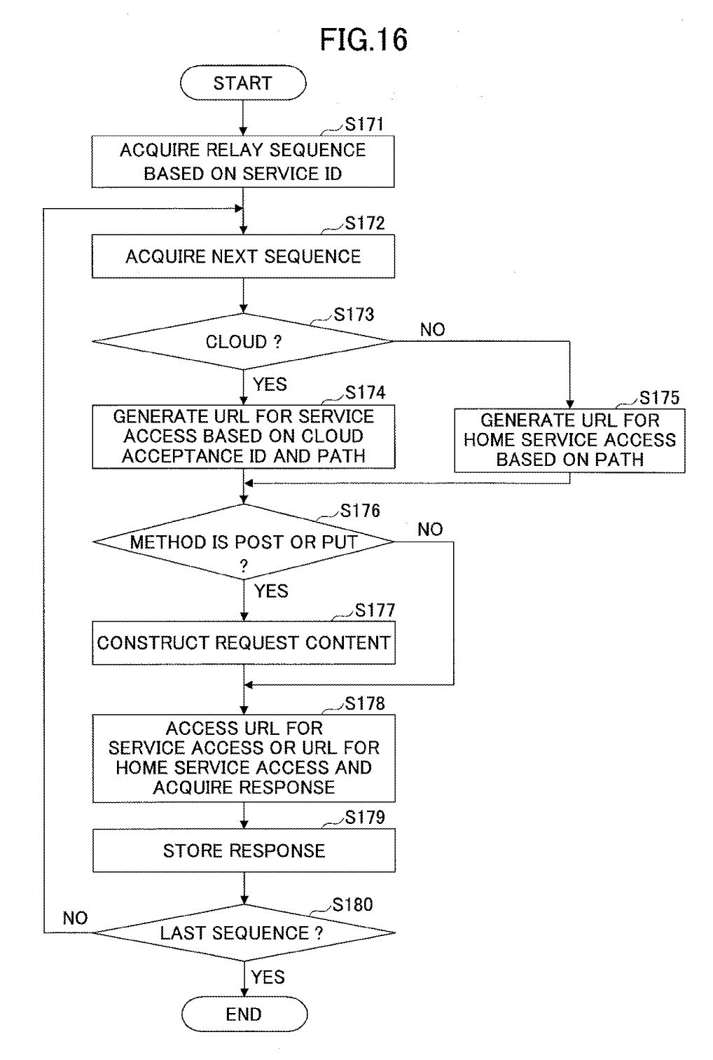

Next, a specific example process in step S167 is described. FIG. 16 is a flowchart of an example process in step S167. In the example of FIG. 16, the access relay section 41 acquires the relay sequence based on the service ID acquired from the access section 22 (step S177). Then, the access relay section 41 acquires the following sequence (step S172).

The relay sequence described above includes, for example, but not limited to, the access destination, the path, the method, and the request. The access destination herein refers to, for example, the information of one of the home terminal 12 and the Cloud 13. The path herein refers to, for example, a path name of the URL. The method herein refers to methods of HTTP, including GET, PUT, and DELETE. The request herein refers to the content which is set in the body part of the HTTP request upon, for example, POST and PUT.

Further, the method described above may be expanded so as to include the method other than that of HTTP. In this embodiment, it is possible to define the access, which is different from the simple POST or GET, such as uploading or downloading a file as the method.

Further, the path and the request described above may be dynamically generated in response to the access to the service. Therefore, a scheme for the dynamic generation is provided. To that end, the access relay section 41 and the service construction section 42 stores the response, which is the result of accessing the service, in the construction service instance 45-2. Further, the path and the request may be generated based on the response which is already stored.

Next, the access relay section 41 determines whether the access destination of the sequence is the Cloud 13 (step S173). When determining that the access destination of the sequence is the Cloud 13 (YES in step S173), the access relay section 41 generates a URL for service access (service access URL) based on the Cloud acceptance ID and the path (step S174).

On the other hand, when determining that the access destination of the sequence is not the Cloud 13 (NO in step S173), the access relay section 41 generates the URL for home service access (home service access URL) based on the path (step S175).

After the process of step S174 or S175, the access relay section 41 determines whether the method in the sequence is one of POST and PUT or not (step S176). When determining that the method in the sequence is one of POST and PUT (YES in step S176), the access relay section 41 constructs the corresponding request content (“request”) (step S177).

On the other hand, when determining that the e method in the sequence is neither POST nor PUT (NO in step S176), the method may be GET, DELETE, or the like. Therefore, the access relay section 41 does not construct a request.

Next, the access relay section 41 accesses the service access URL generated in step S174 or the home service access URL generated in step S175, acquires the response (step S178), and store the acquired response (step S179).

Next, the access relay section 41 determines whether the sequence is the last one (step S180). When determining that the sequence is not the last one (NO in step S180), the process goes back to the process in step S172. When determining that the sequence is the last one (YES in step S180), the access relay section 41 terminates the process.

In the above process, the Cloud acceptance ID is used as the identifier of the service to be registered in the Cloud 13. However, this is an example only and the present invention is not limited to this configuration. For example, another identifier may be used by issuing a predetermined ID by the service registration section 54 upon the registration into the Cloud 13.

### Example Sequence and Response

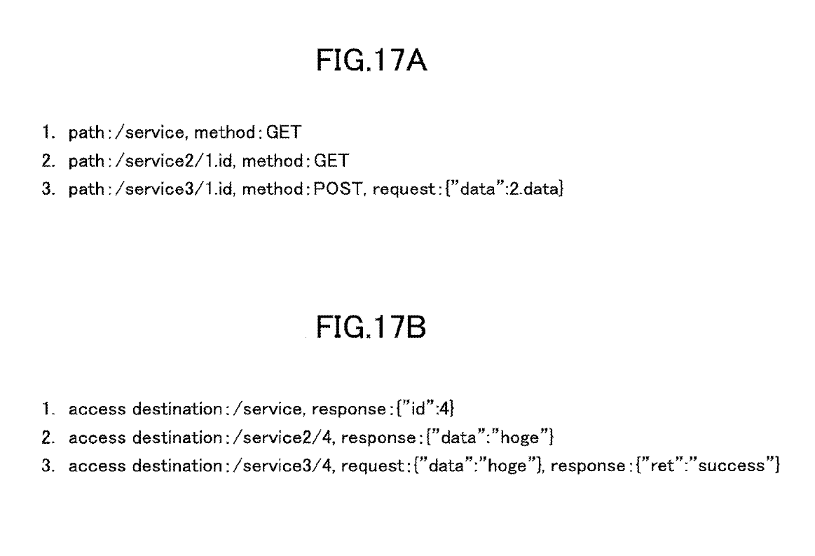

Here, FIGS. 17A and 17B illustrate examples of the sequence and the response. FIG. 17A illustrates an example of the sequence. FIG. 17B illustrates an example of the response as the result of the actual access by the sequence in FIG. 17A.

In FIG. 17A, the sequences of the request sequence Nos. 1 and 2 include the path and the method. The sequence of the request sequence No. 3 includes the path, the method, and the request. However, the information included in the sequence is not limited to those items.

In FIG. 17B, the sequences of the sequence Nos. 1 and 2 of the response include the access destination and the response. The sequence of the sequence No. 3 of the response includes the access destination, the request, and the response. However, the information included in the sequence is not limited to those items.

In the example of FIG. 17A, three sequences having the sequence NOs. 1, 2, and 3 are sequentially executed, so that the sequences of the sequence NOs. 2 and 3 use the result of the response acquired by using the previous sequence(s). The path “1.id” in the path of the sequence Nos 2 and 3 and the “2.data” in the request of the sequence No. 3 correspond to the results of the responses. The “1.id” means that the “id” value of the response in the sequence 1 is used.

The “2.data” means that the “data” value of the response in the sequence 2 is used. In the example of FIGS. 17A and 17B, JSON is used in the request and the response. Therefore, the “id” and the “data” are the keys in JSON.

For example, it is assumed that the response {“id”:4} of FIG. 17B is a result of the response of the access using the sequence No. 1 of FIG. 17A. In this case, the path of the sequence No. 2 is “/service2/4”, and the value of the “id” of the “1.id” is replaced with “4”. Then, the access is done using the replaced value, so that the data {“data”:“hoge”} is acquired.

Further, as the path of the sequence No. 3, the data “/service3/4” is acquired after replacing the “1.id” in the same manner of the sequence No. 2. Further, the request is replaced with the data of the response in the sequence No. 2 to acquire “{“data”:“hoge”}”. Then POST is applied to this data. As a result, the data “{“ret”:“success”}” is acquired as the response.

### Example Process of Service Construction Section 42

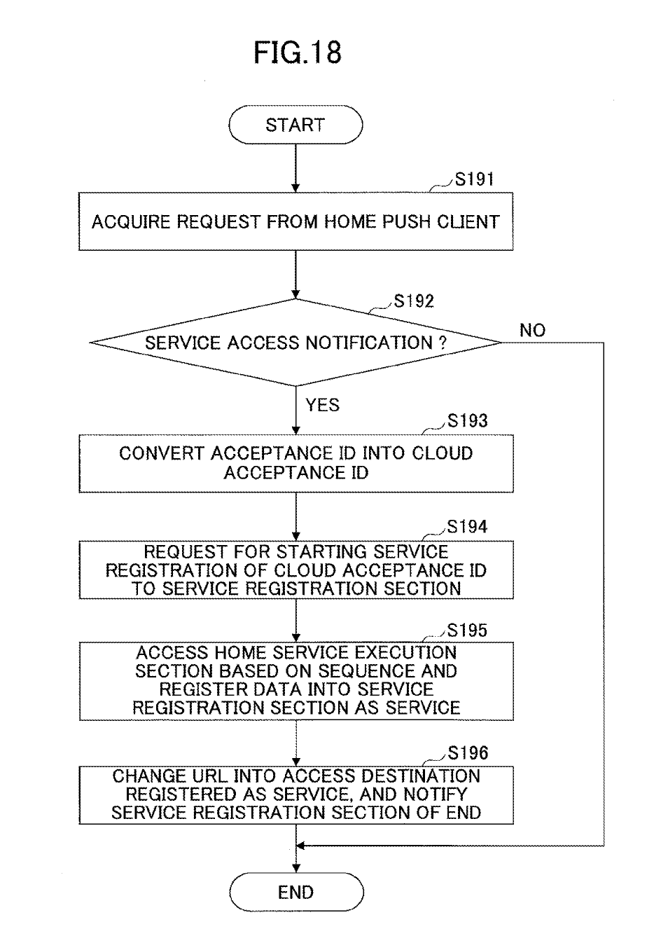

Next, an example process of the service construction section 42 is described with reference to a flowchart. FIG. 18 is a flowchart of an example process of the service construction section 42. In the example of FIG. 18, the service construction section 42 acquires a request from the home Push client 44 (step S191), and determines whether the acquired request is the service access notification (step S192).

When determining that the acquired request is the service access notification (YES in step S192), the service construction section 42 converts the acceptance ID into the Cloud acceptance ID based on the construction service instance 45-2 (step S193). Here, the acceptance ID refers to the information acquired from the home Push client 44 along with the service access notification by the service construction section 42.

Further, the service construction section 42 can acquire not only the acceptance ID but also the Cloud ID, the terminal ID, the service ID, the URL and the like from the home Push client 44.

Next, the service construction section 42 requests for starting service registration of the Cloud acceptance ID to the service registration section 54 by using the Cloud acceptance ID as the identification information (step S194). Next, the service construction section 42 accesses the home service execution section 33 in accordance with the sequence, and resisters data into the service registration section 54 as the service (step S195).

In this case, the service construction section 42 notifies the service registration section 54 of the Cloud ID, the terminal ID, the service ID, the Cloud acceptance ID and the like. A specific example of the process in step S195 is described below.

Next, the service construction section 42 changes the URL, which is notified from the home Push client 44, into the access destination which is service registered, and notifies the service registration section 54 of the termination (step S196). For example, in a case where the URL is “http://192.168.0.2/service”, the URL is changed into “http://cloudhost/2/3/service”.

In the above example, the service construction section 42 changes the host name into the host name of the Cloud 13 which is “cloudhost”, and includes the Cloud ID and the Cloud acceptance ID into the path. In the above example, the Cloud ID is “2” and the Cloud acceptance ID is “3”.

By changing the URL as described above, the service of the Cloud 13 becomes a unique URL. Also, by including the Cloud ID in the path, it becomes possible for the service execution section 53 to acquire the Cloud ID.

Further, when determining that the acquired request is not the service access notification (NO in step S192), the service construction section 42 directly terminates the process.

### Specific Example of Process in Step S195

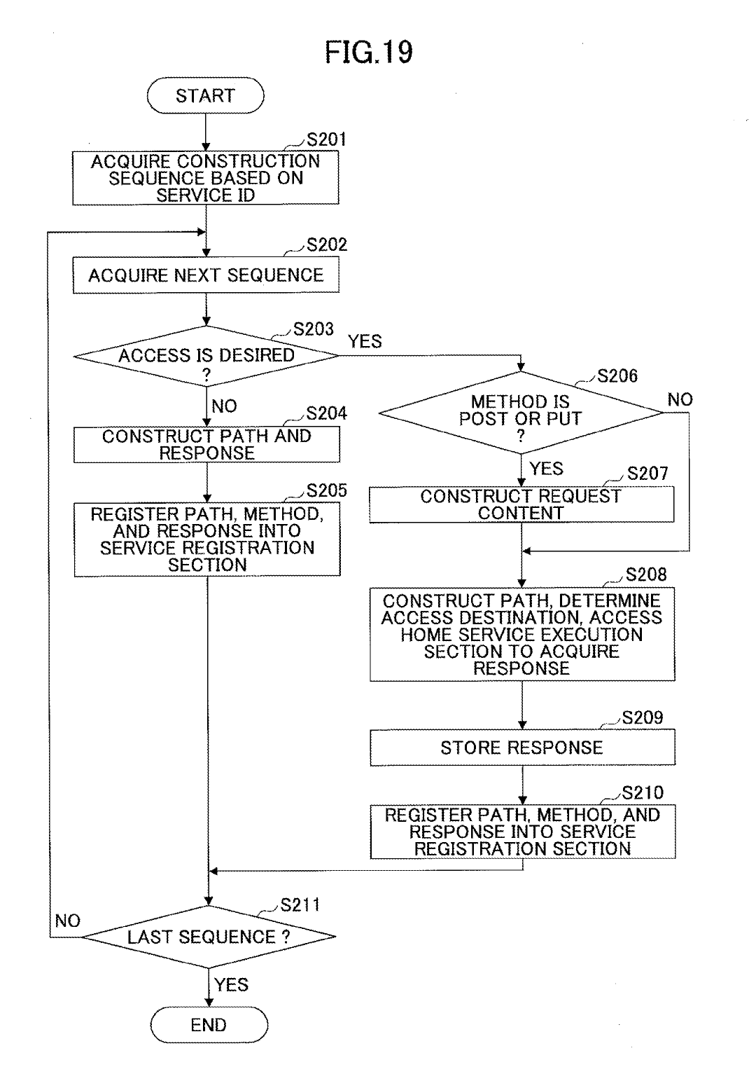

Next, a specific example of the process in step S195 is described. FIG. 19 is a flowchart of an example process in step S195. In the example of FIG. 19, the service construction section 42 acquires the construction sequence based on the service ID (step S201), and then acquires the next sequence (step S202). Here, the service construction section 42 acquires the construction sequence corresponding to the service ID from the service use sequence 45-1, and sequentially execute the sequence.

Here, the construction sequence includes, for example, but not limited to, the path, the method, the request, the response, and the access necessity flag. The path herein refers to, for example, the path name of the URL. The method herein refers to, for example, GET, POST, PUT, and DELETE which are methods of HTTP. The request herein refers to the content to be set in the body part of the HTTP request upon, for example, POST and PUT.

The response herein refers to the response content upon the access of POST and PUT. The access necessity flag indicates whether it is desired to access the home service. Similar to the relay sequence described above, the method may be expanded so as to include the method other than that of the HTTP. Further, similar to the relay sequence, the path, the request, and the response may be constructed based on the stored response.

Next, the service construction section 42 determines whether it is desired to access the home service execution section 33 based on the acquired sequence (step S203). In the process of step S203, the service construction section 42 may determine whether the access is desired by, for example, but not limited to, checking the access necessity flag which is included in the construction sequence.

When determining that it is not desired to access the home service execution section 33 (NO in step S203), the service construction section 42 constructs the path and the response by using the path and the response of the sequence (step S204), registers the information of the path, the method, and the response into the service registration section 54 (step S205). In this case, the service construction section 42 may use the response which is already stored.

On the other hand, when determining that it is desired to access the home service execution section 33 (YES in step S203), the service construction section 42 further determines whether the method is one of POST or PUT (step S206).

When determining that the method is one of POST or PUT (YES in step S206), the service construction section 42 constructs the request content (request) to the home service execution section 33 (step S207). On the other hand, when determining that the method is neither POST or PUT (NO in step S206), the method may be, for example, GET or DELETE. Therefore, the service construction section 42 dose not construct any request.

Next, the service construction section 42 constructs the path, determines the access destination of the home service in the home service execution section 33, and acquires the response by accessing the home service execution section 33 (step S208). Next, the service construction section 42 stores the acquired response in association with the sequence number (step S209).

Next, the service construction section 42 registers the path, the method, and the response into the service registration section 54 (step S210).

Next, after the process of step S205 or S210, the service construction section 42 determines whether the sequence is the last one (step S211). When determining that the sequence is not the last one (NO in step S211), the process goes back to the process in step S202.

On the other hand, when determining that the sequence is the last one (YES in step S211), the service construction section 42 terminates the process.

### Examples of Service Use Sequence 45-1 and Construction Service Instance 45-2

Next, examples of the service use sequence 45-1 and the construction service instance 45-2 are described.

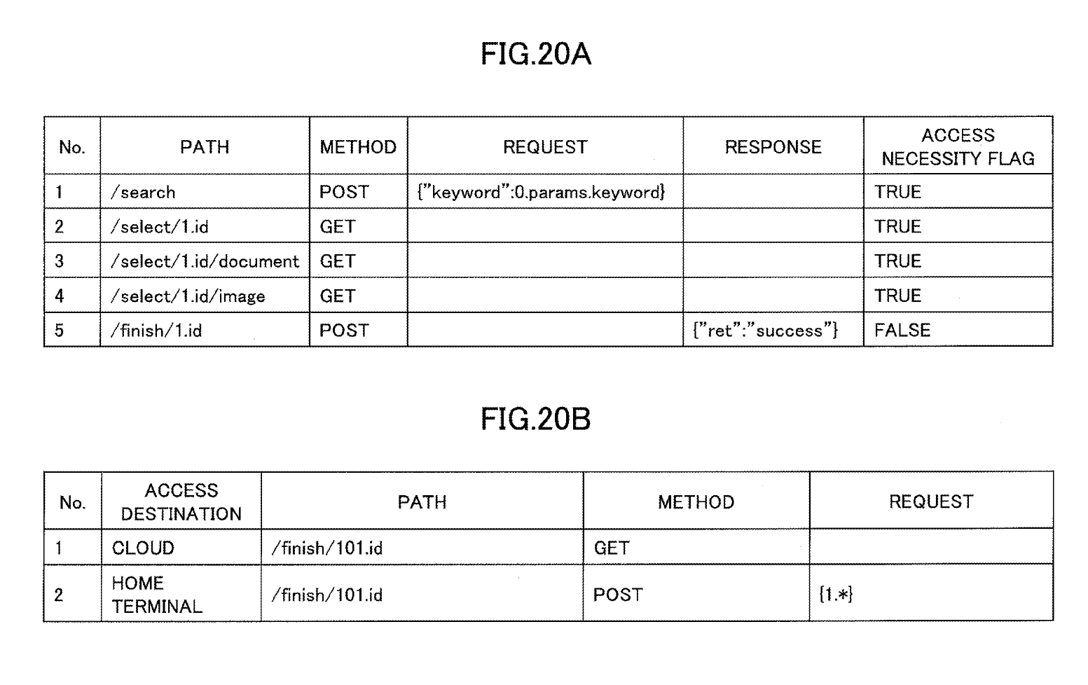

FIGS. 20A and 20B illustrate an example of the service use sequence 45-1. FIG. 20A illustrates an example construction sequence in the service use sequence 45-1 of the home terminal 12. FIG. 20B illustrates an example relay sequence in the service use sequence 45-1 of the home terminal 12.

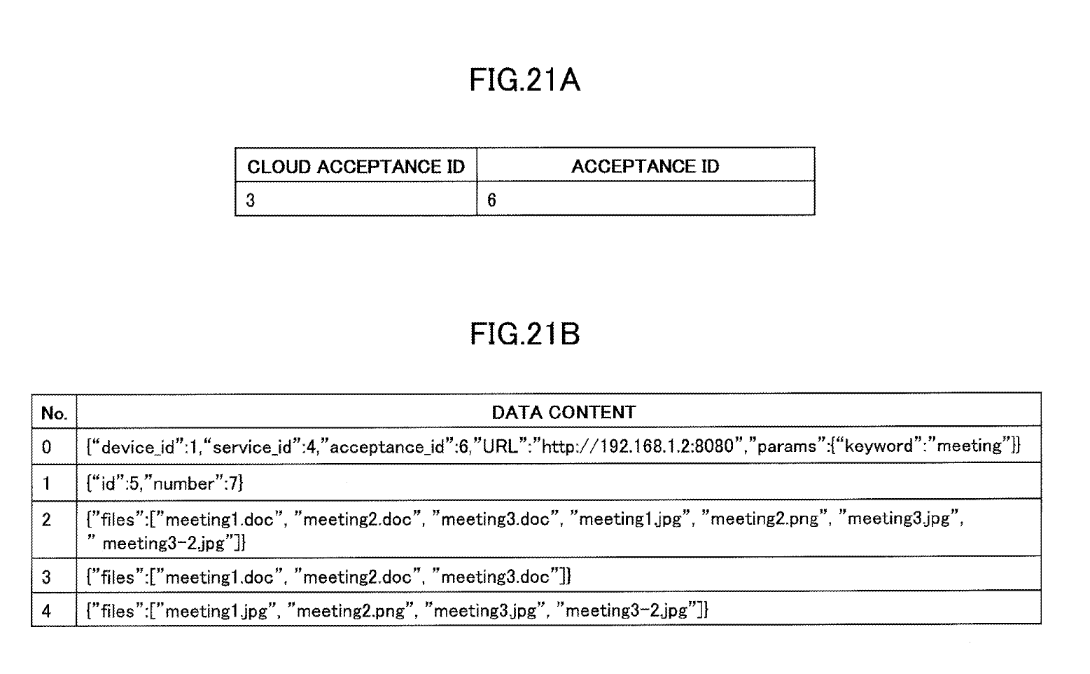

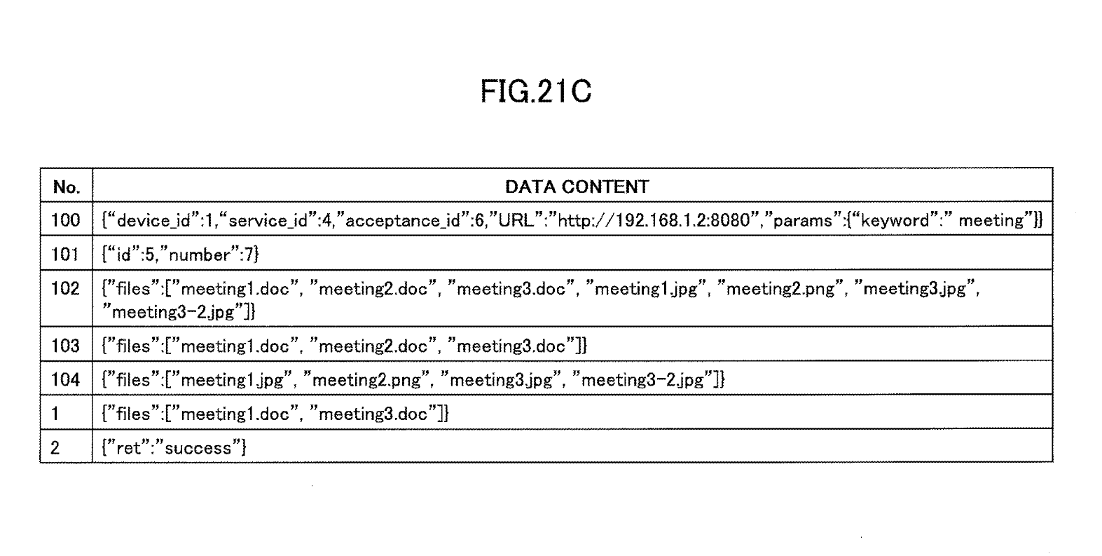

Further, FIGS. 21A through 21C illustrate an example construction service instance 45-2. FIG. 21A illustrates a relationship between the acceptance ID and the Cloud acceptance ID. FIG. 21B illustrates an example response of service construction. FIG. 21C illustrates an example response of access relay.

The service construction section 42 accesses the home service execution section 33 by using the construction sequence as illustrated in FIG. 20A, executes the service, and acquires the data content (response) as illustrated in FIG. 21B. Further, the access relay section 41 executes the service by using the relay sequence as in FIG. 20B, and acquires the data contents (response) as in FIG. 21C.

The symbol {1.*}, which is described in the request (request content) of the sequence number (No.) of the relay sequence in FIG. 20B, denotes all the responses of the access of the sequence number 1.

With reference to FIGS. 20A and 20B, a case is described where, in the reference to the response in the relay sequence, only the reference of the corresponding sequence is referred to. However, when the sequence number of the construction sequence and the relay sequence is numbered serially, it becomes possible to refer to the response of the construction sequence from the relay sequence.

For example, it becomes possible to manage the relay sequence numbers in the 100s as the response of the construction sequence.

Further, in the above example, a case is descried where the access to the service is identified by using the path and the method. However, there may be a case where such as in POST, the path and the method do not change but responses may change depending on the request content.

Even in such a case, according to this embodiment, it is possible to correspond to the case by changing the service construction section 42, the access relay section 41, the service registration section 54, and the service execution section 53 so as to identify the access including the request content.

In the construction service instance 45-2, as illustrated in FIG. 21A, the Cloud ID is managed in association with the acceptance ID. Further, in the examples of FIGS. 21B and 21C, the data content of the response for each sequence number is illustrated.

The data whose sequence number is in the 100s in the access relay of FIG. 21C indicates the response of the construction sequence as described above.

In the data example of FIGS. 20A through 21C, an example service use is illustrated where a file search is executed from the request terminal 11 in the home terminal by using a predetermined keyword (e.g., “meeting”), and the search result is acquired.

Further, the request terminal 11 displays a first list including three document files (documents) or four image files (images) from a second list including seven files acquired as the result of the search using the keyword, so that plural files are selected from the first list. It should be noted that the service used according to this embodiment is not limited to the above example.

### Example Process of Cloud Push Service 51

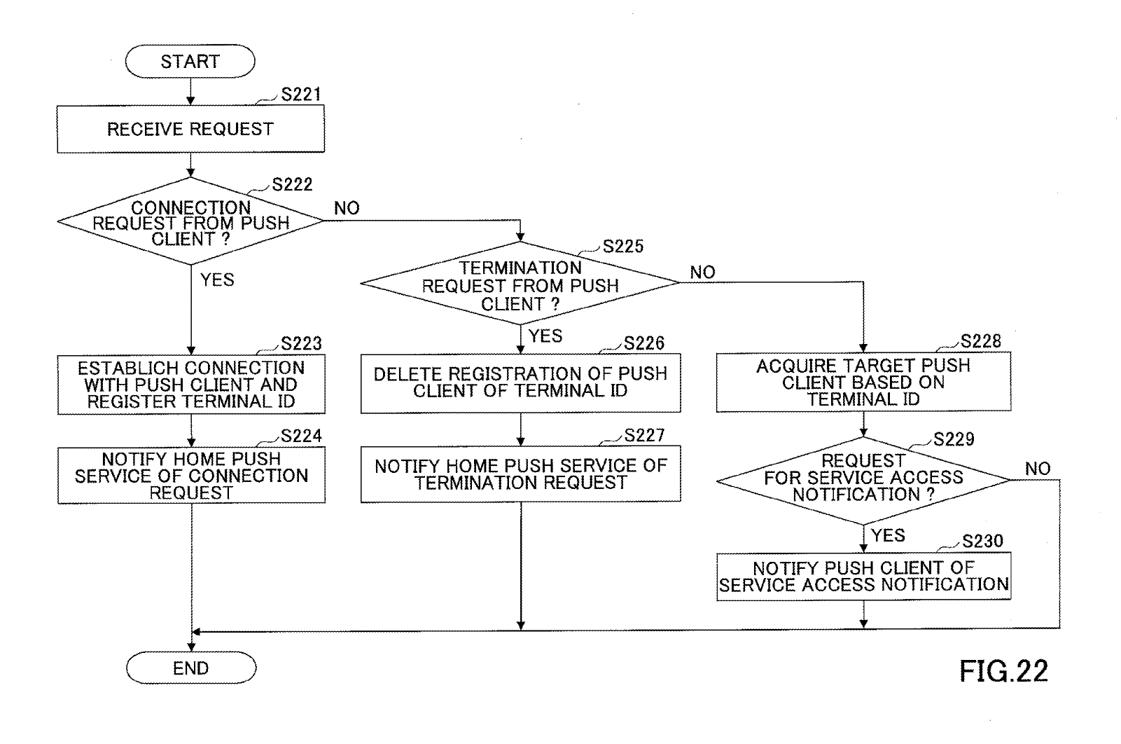

Next, an example process of the Cloud Push service 51 in the Cloud 13 is described with reference to a flowchart. FIG. 22 is a flowchart of an example process of the Cloud Push service 51. In the example of FIG. 22, the Cloud Push service 51 receives a request from the request terminal 11 (step S221), and determines whether the received request is the connection request from the Push client 23 (step S222).

When determining that the received request is the connection request from the Push client 23 (YES in step S222), the Cloud Push service 51 establishes the connection with the Push client 23, and registers the terminal ID of the request terminal 11 corresponding to the Push client 23 having the established connection with the Cloud Push service 51 (step S223). Then, the Cloud Push service 51 notifies the home Push service 55 of the connection request (step S224).

On the other hand, when determining that the received request is not the connection request from the Push client 23 (NO in step S222), the Cloud Push service 51 further determines whether the received request is the terminate request from the Push client 23 (step S225).

When determining that the received request is the terminate request from the Push client 23 (YES in step S225), the Cloud Push service 51 deletes the registration of the Push client 23 of the terminal ID (step S226), and notifies the home Push service 55 of the terminate request (step S227).

On the other hand, when determining that the received request is not the terminate request (NO in step S225), the Cloud Push service 51 acquires the target Push client 23 based on the terminal ID (step S228), and determines whether the received request is the service access notification from the service registration section 54 (step S229).

When determining that the received request is the service access notification from the service registration section 54 (YES in step S229), the Cloud Push service 51 sends the service access notification to the Push client 23 (step S230). After any of the processes in steps S224, S227, and S230, the Cloud Push service 51 terminates the process. On the other hand, when determining that the received request is not the service access notification (NO in step S229), the Cloud Push service 51 does not do anything or may output an error message.

The example process of FIG. 22 refers to the Push service using the so-called Cloud 13.

This Push service using the Cloud differs from the Push service in home use in that, for example, in the connection from the request terminal 11, the connection request is notified to the home Push service 55, and based on the termination from the request terminal 11, the terminate request is notified to the home Push service 55 in the case of using the Cloud 13.

### Example Process of Home Push Service 55

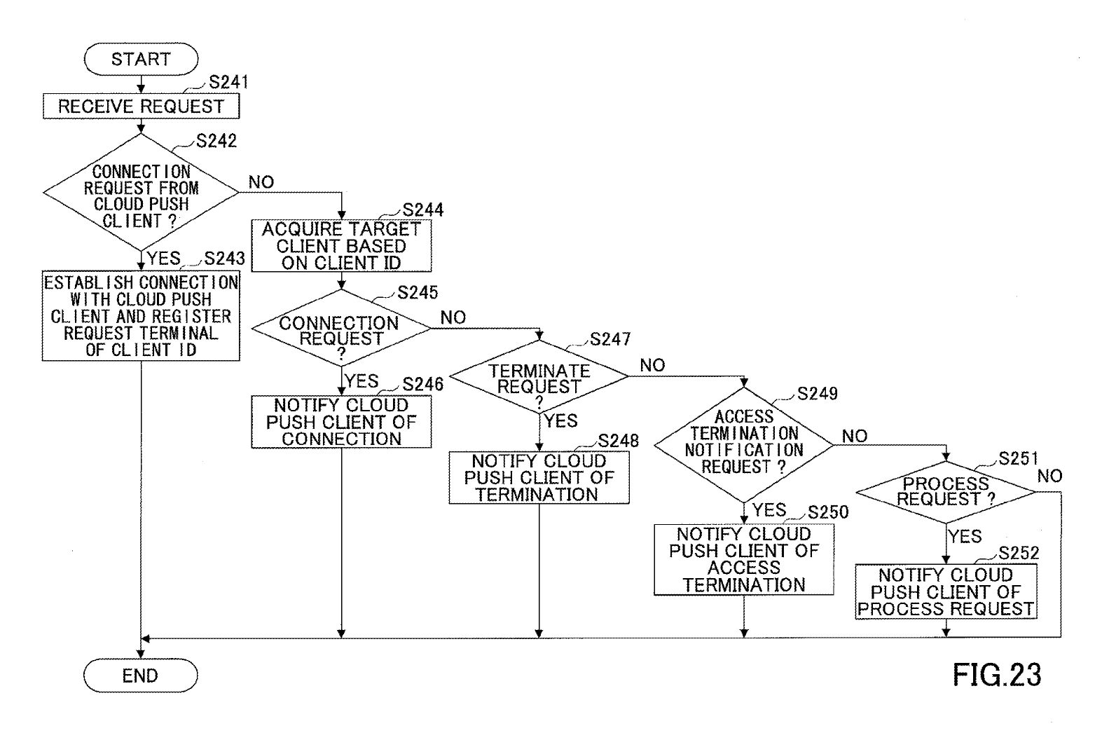

Next, an example process of the home Push service 55 is described with reference to a flowchart. FIG. 23 is a flowchart of an example process of the home Push service 55. In the example of FIG. 23, the home Push service 55 receives a request (step S241), and determines whether the receive request is the connection request from the Cloud Push client 43 of the home terminal 12 (step S242).

When determining that the receive request is the connection request from the Cloud Push client 43 of the home terminal 12 (YES in step S242), the home Push service 55 establishes the connection with the Cloud Push client 43, and registers the client ID of the request terminal whose connection is established (step S243).

On the other hand, when determining that the receive request is not the connection request from the Cloud Push client 43 (NO in step S242), the home Push service 55 acquires the target Cloud Push client 43 based on the client ID, and further determines whether the received request is the connection request (step S245). When determining that the received request is the connection request (YES in step S245), the home Push service 55 sends the connection request to the target Cloud Push client 43 (step S246).

On the other hand, when determining that the received request is not the connection request (NO in step S245), the home Push service 55 further determines whether the received request is the terminate request (step S247). When determining that the received request is the terminate request (YES in step S247), the home Push service 55 sends the terminate request to the Cloud Push client 43 (step S248).

On the other hand, when determining that the received request is not the terminate request (NO in step S247), the home Push service 55 determines whether the received request is an access termination notification request (step S249). When determining that the received request is the access termination notification request (YES in step S249), the home Push service 55 sends the access termination notification request to the Cloud Push client 43 (step S250).

On the other hand, when determining that the received request is not the access termination notification request (NO in step S249), the home Push service 55 further determines whether the received request is the process request (step S251). When determining that the received request is the process request (YES in step S251), the home Push service 55 notifies the Cloud Push client 43 of the process request (step S252).

After any of the processes in steps S243, S246, S248, S250, and S252 or when determining that the received request is not the process request (NO in step S251), the home Push service 55 terminates the process.

As described above, in the process of FIG. 23, in the case of the connection from the Cloud Push client 43, the connection with the client is established, and the connection is managed in association with the client ID. The connection request and the terminate request are received from the home Push service 55. In this case, the Cloud Push client 43 is acquired based on the Could ID, and the connection notification or the terminate notification is transmitted to the Cloud Push client 43.

In the case of access termination notification from the service execution section 53, the Cloud Push client 43 is acquired based on the client ID, and the access termination notification is transmitted to the Cloud Push client 43.

Further, in the case of the process request from the Cloud process receiving section 52, the Cloud Push client 43 is acquired based on the client ID, and the process request notification is transmitted to the Cloud Push client 43.

### Example Process of Cloud Process Receiving Section 52

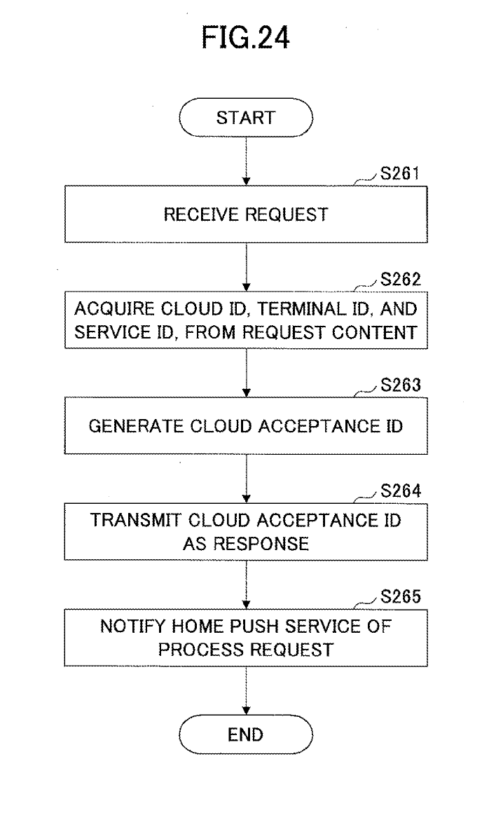

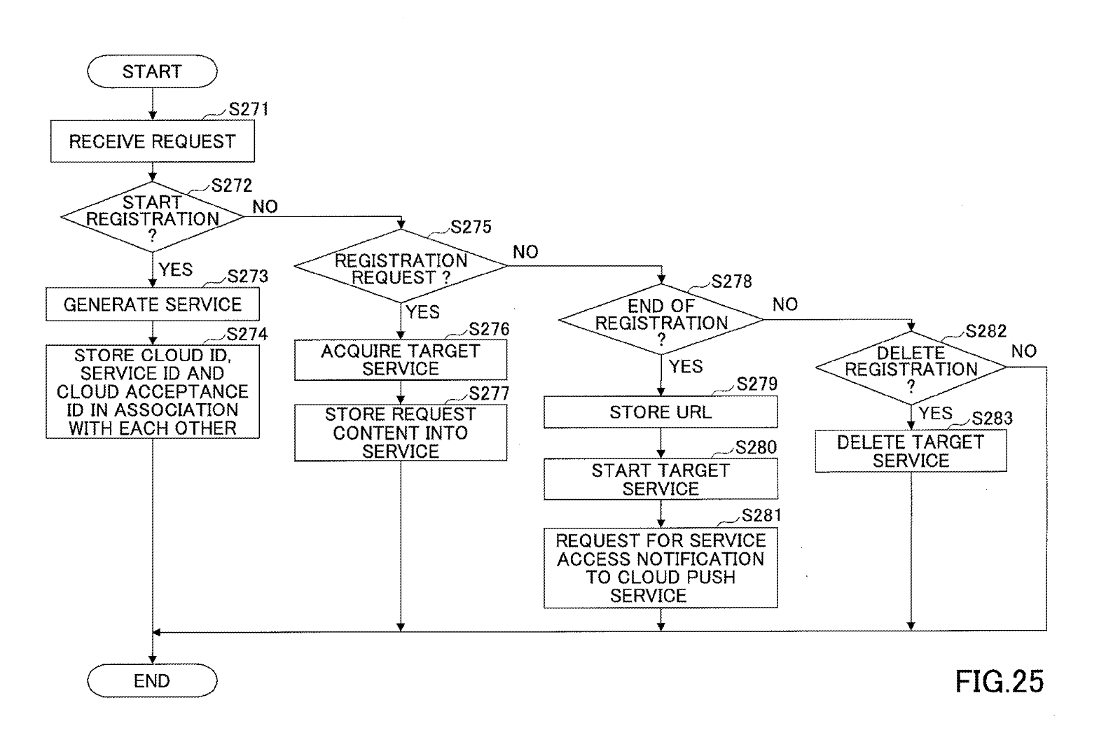

Next, an example process of the Cloud process receiving section 52 is described with reference to a flowchart. FIG. 25 is a flowchart of an example process of the Cloud process receiving section 52. In the example of FIG. 24, the Cloud process receiving section 52 receives a request content from the request terminal (step S261), and acquires the Cloud ID, the terminal ID, the service ID and the like based on the received request (step S262).

The Cloud ID is acquired in a case where the process is not received in the home area 15, and for example, the information designated nu the URL or the like may be acquired.

Next, the Cloud process receiving section 52 generates the Cloud acceptance ID (step S263), and transmits the generated Cloud acceptance ID to the request terminal as the respond (step S264).

Next, the Cloud process receiving section 52 sends the process request notification to the home Push service 55 by using, for example, the Cloud acceptance ID, the Cloud ID, the terminal ID, and the service ID as arguments (step S265).

### Example Process of Service Registration Section 54

Next, an example process of the service registration section 54 is described with reference to a flowchart. FIG. 25 is a flowchart of an example process of the service registration section 54. In the example of FIG. 25, the service registration section 54 receives a request from the service construction section 42 or the access relay section 41 of the home terminal 12 (step S271).

In this embodiment, for example, requests of registration start, registration, and registration end are received from the service construction section 42 and a request of registration deletion is received from the access relay section 41. It should be noted, however, this is an example only and the present invention is not limited to this configuration.

The service registration section 54 determines whether the received request is the registration start request (step S272). When determining that the received request is the registration start request (YES in step S272), the service registration section 54 generates the service corresponding to the request (step S273).

In the process of step S273, to provide as service by the service execution section 53, for example, a region for the service where the Cloud acceptance ID is used as a key is generated for the registration service 56-1. Next, the service registration section 54 stores the Cloud ID in association with the service ID and the Cloud acceptance ID as the service information (step S274).

On the other hand, when determining that the received request is not the registration start request (NO in step S272), the service registration section 54 further determines whether the received request is the registration request (step S275).

When determining that the received request is the registration request (YES in step S275), the service registration section 54 acquires the target service from the registration service 56-1 based on the Cloud acceptance ID (step S276).

Next, the service registration section 54 stores the request content of the acquired service (step S277). When there are more than one request contents, the service registration section 54 adds the request contents to the service.

On the other hand, when determining that the received request is not the registration request (YES in step S275), the service registration section 54 further determines whether the receive request is the registration end request (step S278).

When determining that the receive request is the registration end request (YES in step S278), the service registration section 54 stores the URL which is an example of the address information of the registered service (step S279), and starts the target service (step S280).

The start of the service herein means that when, for example, the service execution section 53 is accessed, the access to the service is permitted. Further, the service registration section 54 requests for the service access notification to the Cloud Push service 51 (step S281).

On the other hand, when determining that the receive request is not the registration end request (NO in step S278), the service registration section 54 further determines whether the received request is the registration deletion request (step S282). When determining that the received request is the registration deletion request (YES in step S282), the service registration section 54 deletes the target service (step S283).

In the process of step S283, for example, the service registration section 54 refers to the registration service 56-1 based on the Cloud acceptance ID, acquires the target service, and deletes the information of the service. Further, the service registration section 54 refers to the request 56-2 based on the Cloud acceptance ID, acquires the information for the service, and deletes the information.

After any of the processes in steps S274, S277, S281, and S283, or when determining that the received request is not the registration deletion request (NO in step S282), the service registration section 54 terminates the process.

Further, in the process of step S282, when the received request is not the registration deletion request, the service registration section 54 may output an error message or the like.

### Example Data of Registration Service 56-1

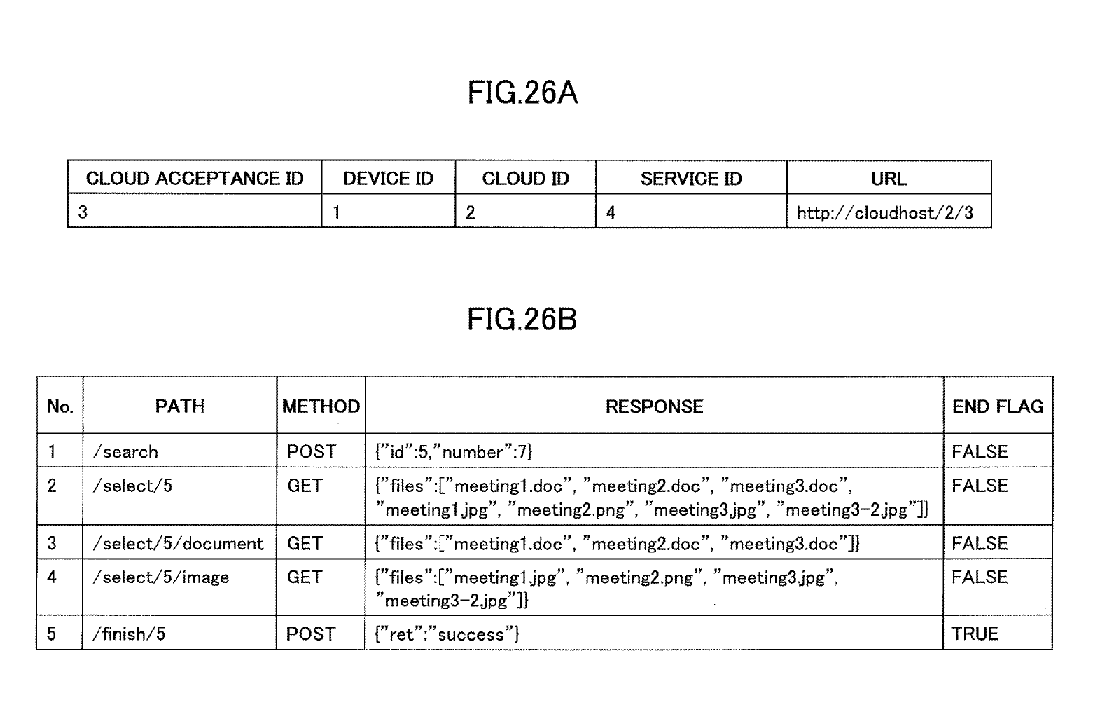

Next, example data of the registration service 56-1 are described with reference to the drawings. FIGS. 26A and 26B illustrate example data of the registration service. FIG. 26A illustrates example data for each service, and FIG. 26B illustrates example data for each registration.

As the information items (content) to be stored per each service in FIG. 26A, the content to be stored in the registration service 56-1 includes, for example, but not limited to, the Cloud acceptance ID, the device ID, Cloud ID, the service ID, and the URL. The service registration section 54 registers the services in the Cloud 13 by managing the information items as illustrated in FIG. 26A.

Further, as the information items to be stored per each registration, there are, for example, but not limited to, the path, the method, the response, and an end flag which are request content.

In the example of FIG. 26B, a service is illustrated where a keyword search is preformed from the request terminal 11 in the home terminal 12 via the Cloud 13, and a list of the acquired files is generated. As a result, the document files and the image files are classified and the list thereof is transmitted as a response.

The access of the home service acquires the ID based on “/search” for acquiring a file list. In the “/search”, the response is acquired by POSTing {“keyword”:“meeting”}. Further, a list is acquired based on the “/select”. Further, a file is selected from the file list, and the list is POSTed to “/finish”. This is the service use termination.

The end flag in FIG. 26B is included in, for example, the request content from the service construction section 42. When the value of the end flag is TRUE, the service is determined to be terminated. Further, the service registration section 54 stores the URL upon ending the registration as illustrated in FIG. 26A.

### Example Process of Service Execution Section 53

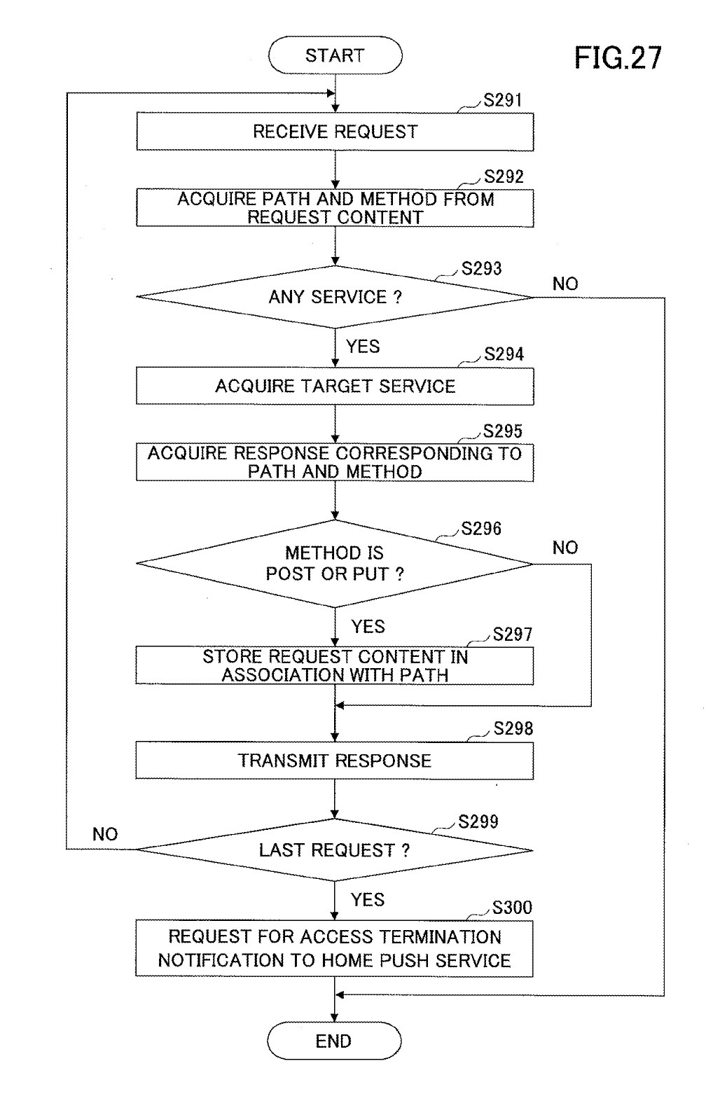

Next, an example process of the service execution section 53 is described with reference to a flowchart. FIG. 27 is a flowchart of an example process of the service execution section 53. The service execution section 53 operates based on the access from the access section 22 of the request terminal 11 or the access relay section 41 of the home terminal 12.

In the example of FIG. 27, the service execution section 53 receives a request (step S291), and acquires the path and the method based on the request content (step S292). Here, in the process of step S292, when the information of the Cloud ID and the Cloud acceptance ID are included in the path of the request, the service execution section 53 assumes that the information excluding those IDs is the path.

Next, the service execution section 53 determines whether a service is included in the request (step S293). When determining that the request is included (YES in step S293), the service execution section 53 acquires the target service (step S294), and further acquires the response corresponding to the path and the method (step S295).

In the process of step S295, the service execution section 53 acquires the service from the registration service 56-1 based on the Cloud acceptance ID, and further acquires the respond by using the path and the method as keys.

Further, in this embodiment, when the request is transmitted from the access relay section 41 of the home terminal 12, the service execution section 53 may acquire the response based on the information stored in the request 56-2.

Next, the service execution section 53 determines whether the method is one of POST and PUT (step S296). When determining that the method is one of POST and PUT (YES in step S296), the service execution section 53 stores the request content in association with the path as the request content of the Cloud ID into the request 56-2 (step S297).

On the other hand, when determining that the method is neither POST nor PUT (NO in step S296), the method may be, for example, GET, or DELETE. Therefore, the service execution section 53 does not store the request content in association with the path.

Next, the service execution section 53 transmits the response which is acquired in the process of step S295 (step S298), and determines whether the received request is the last one (step S299). In the process of step S299, the service execution section 53 may determine that the received request is the last one when, for example, but not limited to the value of the end flag included in the request content is TRUE.

When determining that the received request is not the last one (NO in step S299), the process goes back to the process of step S291. On the other hand, when determining that the received request is the last one (YES in step S299), the service execution section 53 requests for the access termination notification to the home Push service 55 (step S300).

Further, when determining that no service is included (NO in step S293), the service execution section 53 terminates the process. In this case, the service execution section 53 may send an error message to the requesting request terminal 11 or the home terminal 12.

Similarly, in the process of step S295, when the response corresponding to the path and the method cannot be acquired, the service execution section 53 may send an error message to the requesting request terminal 11 or the home terminal 12.

### Example Data of Request 56-2

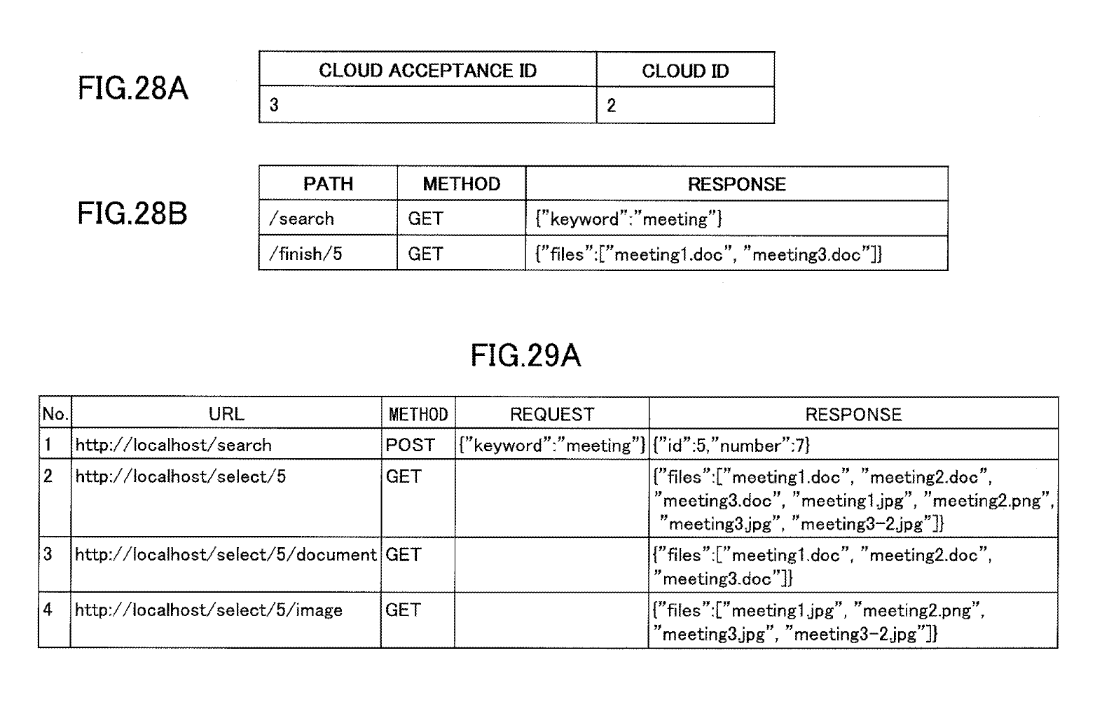

Next, example data of the request content (request) is described with reference to the drawings. FIGS. 28A and 28B illustrate example data of the request. FIG. 28A illustrates example request data for each service and FIG. 28B illustrates example request data for each access.

In the example request data of FIG. 28A, the Cloud acceptance ID is in association with the Cloud ID. Further, in the example request data of FIG. 28B, the path, the method, and the response are associated with each other.

Here, the stored request 56-2 is acquired from the access relay section 41 of the home terminal 12. Therefore, the method is fixed to GET, and the response is the storage destination of the request. The service execution section 53 transmits the acquired response to the requesting request terminal 11 or the home terminal 12.

### Specific Example of Service Use

Next, a specific example of the service use is described when the information processing system 10 according to this embodiment is used. In the following, a case is described where the request terminal 11-2, which is located in the out-of-home area, uses the home service, which is provided by the home terminal, via the Cloud 13.

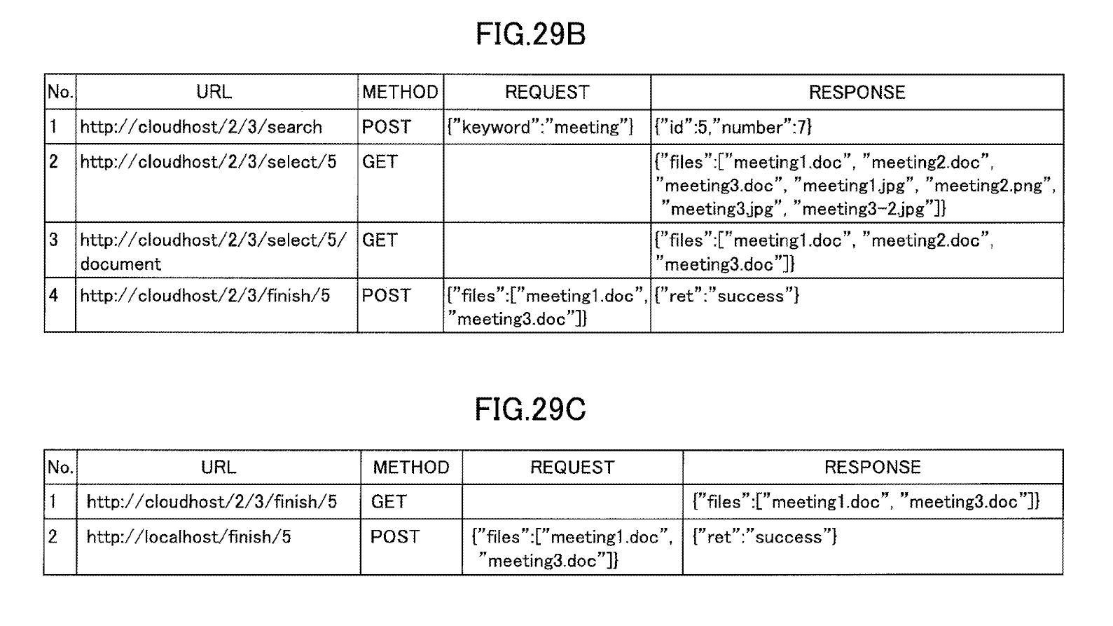

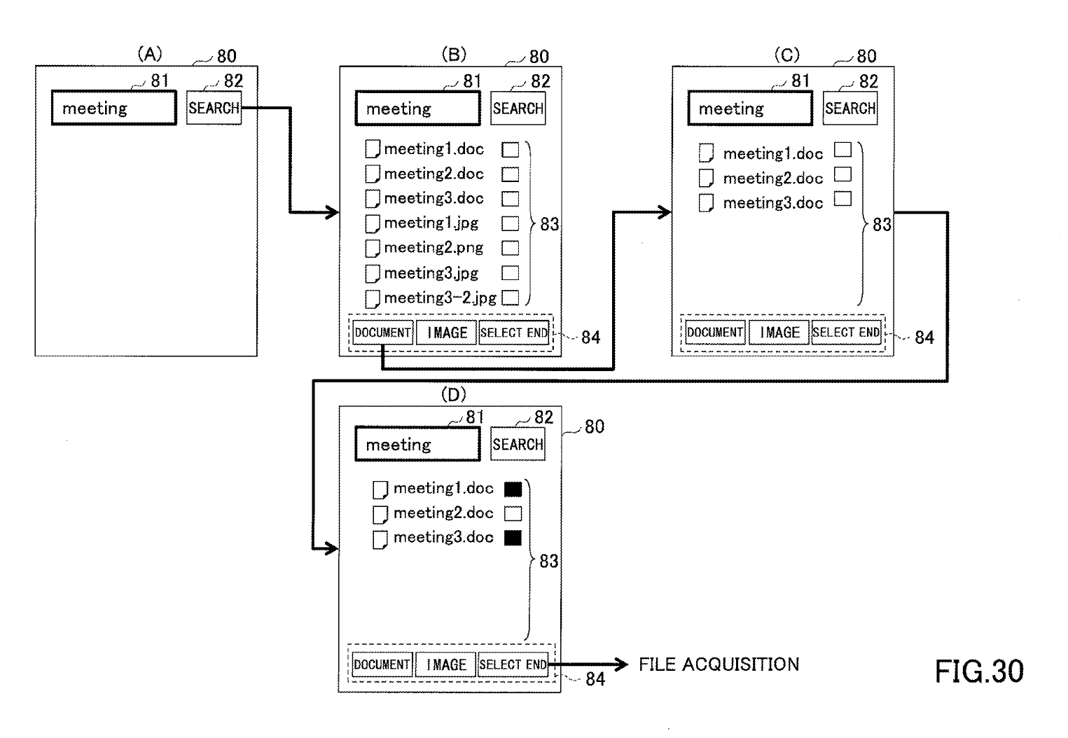

FIGS. 29A through 29C illustrate a specific example of data when a service is used. FIG. 30 illustrates example screens of the request terminal when the service is used.

FIG. 29A illustrates example access data to the home service execution section 33 of the home terminal 12. FIG. 29B illustrates example access data of the access section 22 in the request terminal 11-2. FIG. 29C illustrates example access relay data. Parts (A) through (D) of FIG. 30 illustrates the screen transition of the screen when the service is used.

A screen 80 of the request terminal 11-2 in part (A) of FIG. 30 includes a input area 81, into which a search keyword is input, and a search button 82 to execute a search process as an example use of the home service. Here, the screen 80 may be, for example, but is not limited to, a browser screen. For example, the screen 80 may be displayed by a dedicated application.

In this embodiment, when, for example, a user inputs a search keyword (e.g., “meeting”) into the input area 81 of the screen 80 in part (A) of FIG. 30 and presses the search button 82, a search is done in the home terminal 12 via the Cloud 13 based on the keyword “meeting” which is input in the input area 81 (FIG. 29A).

Then, the search result is stored in the Cloud 13, and the service is provided to the request terminal 11 by the Cloud 13. The search keyword is transferred to, for example, the Cloud process receiving section 52. Here, when the request terminal 11 is located in the home area 15, the request terminal 11 directly accesses the home terminal 12.

FIG. 29A illustrates a case where after the search button 82 in part (A) of FIG. 30 is pressed by, for example, a user's instructions, the service construction section 42 of the home terminal 12 accesses the home service execution section 33.

In the example of part (B) of FIG. 30, the screen 80 includes a display area 83 and a button display area 84. The display 83 displays files which are acquired as a result of the search, and the button display area 84 displays buttons to, for example, extract a file fulfilling a predetermined condition among the files displayed in the display area 83.

In the example of part (B) of FIG. 30, as the buttons in the button display area 84, there is a “document” button to extract (select) only a document file, an “image” button to extract only an image file, and a “select end” button to end selection. However, it should be noted that the present invention is not limited to this configuration. Part (B) of FIG. 30 illustrates an example screen which is based on the access result of sequence No. 2 in FIG. 29B.

When the request terminal 11 requests to select the document file from among the seven files (including three document files and four image files) in the display area 83, the request is transmitted to the Cloud 13, so that the process relative to the home terminal 12 is executed. As a result from the Cloud 13 side, the screen 80 including three document files as illustrated in part (C) of FIG. 30 is displayed in the request terminal 11 (corresponding to the sequence No. 3 in FIG. 29B).

Further, the display area 83 of the request terminal 11 displays check boxes of the displayed files, so that the user can select a file and press the “select end” button to acquire the selected file. Part (D) of FIG. 30 illustrates a case where two files “meeting1.doc” and “meeting2.doc” are selected, which is a notification example of a result of the file selection of the sequence No. 4 in FIG. 29B.

In response to the notification of the selection result, the service execution section 53 of the Cloud 13 acknowledges the end of access, and notifies the end of access to the access relay section 41 via the home Push service 55 and the Cloud Push client 43. Then, the access relay section 41 executes the sequence of FIG. 29C.

According to this embodiment described above, it becomes possible to provide an appropriate service. For example, according to this embodiment, when a home service is added, the home service can be used not only in home but also in the out-of-home area without modifying the Cloud.

Also, only a temporary service is construction in the Cloud to reproduce the access sequence to the home service. Therefore, it is not desired to use different accessing methods from the request terminal depending on whether the request terminal is in the home area or in the out-of-home area. Therefore, it becomes possible to provide data with improved convenience.

Further, according to this embodiment, it becomes possible to directly reproduce the home service in the Cloud by accessing the home service by proxy, registering the access result and the access type, and providing the service based on the registration content. Further, according to an embodiment, it becomes possible to reproduce the home service in the Cloud even when the home service is an interactive service.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiments of the present inventions have been described in detail, it is to be understood that various changes, substitutions, and alterations could be made hereto without departing from the spirit and scope of the invention.

What is claimed is:

1. An information processing system comprising:
first and second terminals which are in communication with each other via one or more computers on a network, so that a process of the second terminal is executed by the first terminal via the network,
wherein the second terminal includes:
an access proxy unit configured to
acquire a request from the first terminal via the one or more computers on the network,
construct a process sequence corresponding to the acquired request, and
output a process result corresponding to the constructed process sequence, and
an execution unit configured to execute a process corresponding to the constructed process sequence.

2. The information processing system according to claim 1,
wherein the second terminal further includes:
a registration unit configured to register the process result which is acquired by the access proxy unit, and
a service providing unit configured to provide a service corresponding to the process result registered by the registration unit.

3. The information processing system according to claim 1,
wherein the first terminal includes
a network monitoring unit configured to
monitor connection destination information which is acquired upon connection to the network, and
determine whether to directly access the second terminal or access the second terminal via the one or more computers on the network.

4. The information processing system according to claim 1,
wherein an access of the first terminal is asynchronous with an access of the second terminal.

5. An information processing apparatus comprising:
an access proxy unit configured to
acquire a request from a terminal via one or more computers on the network,
construct a process sequence corresponding to the acquired request, and
output a process result corresponding to the constructed process sequence, and
an execution unit configured to execute a process corresponding to the constructed process sequence.

6. A computer-readable non-transitory recording medium having stored therein a data analyzing program that causes a computer to execute a process, the process comprising:
acquiring a request from a terminal via one or more computers on the network,
constructing a process sequence corresponding to the acquired request, and
outputting a process result corresponding to the constructed process sequence, and
executing a process corresponding to the constructed process sequence.

7. A method of processing information and being used in an information processing apparatus, the method comprising:
acquiring a request from a terminal via one or more computers on the network,
constructing a process sequence corresponding to the acquired request, and
outputting a process result corresponding to the constructed process sequence, and
executing a process corresponding to the constructed process sequence.
